(19) United States
(12) Patent Application Publication
(10) Pub. No.: US 2016/0185588 A1
(43) Pub. Date: Jun. 30, 2016

(54) Coupling Device

(71) Applicant: BASF SE, Ludwigshafen (DE)

(72) Inventors: Robert HUBER, Limburgerhof (DE); Juan SASTURAIN, Limburgerhof (DE); Richard GARNETT, Hereford (GB)

(73) Assignee: BASF SE, Ludwigshafen (DE)

(21) Appl. No.: 14/911,175

(22) PCT Filed: Aug. 14, 2014
(86) PCT No.: PCT/EP2014/067424

§ 371 Date: Feb. 9, 2016

(30) Foreign Application Priority Data
Aug. 14, 2013 (EP) 13180473.4
Aug. 14, 2013 (EP) 13180477.5
Aug. 14, 2013 (EP) 13180478.3
Jun. 16, 2014 (EP) 14172542.4

(51) Int. Cl. B67D 7/02

(52) U.S. Cl. CPC B67D 7/0288

(57) ABSTRACT

The present invention relates to a coupling device configured to be mechanically coupled to a springless cap of a container to be in a coupled configuration. The coupling device comprises a first probe configured to be inserted into a first opening of the cap, a second probe configured to be inserted into a second opening of the cap, a first sleeve configured to cover a first extraction aperture of the first probe and a second sleeve configured to cover a second extraction aperture of the second probe. The first sleeve is slideably attached to the first probe and the second sleeve is slideably attached to the second probe. Furthermore, the coupling device is configured, when in the coupled configuration, to disengage a first closure insert of the cap from a first shoulder of the cap by axially pushing the first closure insert with the first probe. The coupling device is also configured, when in the coupled configuration, to disengage a second closure insert of the cap from a second shoulder of the cap by axially pushing the second closure insert with the second probe. In an embodiment the coupling device comprises a probe translation control mechanism and/or a sleeve translation control mechanism. The plugs in the cap may have a spring function derived from a material memory in the legs of the plug and this is used to retain the plugs in position and sealed.

### FIELD OF THE INVENTION

The present invention relates to the handling of liquids and solid state media stored in containers which are opened and closed by means of a coupling device. In particular, the present invention relates to a coupling device configured to be coupled to a cap of a container, a system for draining and venting a container and a method of mechanically coupling a coupling device to a cap of a container.

### BACKGROUND OF THE INVENTION

In many technical fields, like for example in the field of liquids, liquids are used which may be hazardous for the user or operator. It is therefore a desire to provide for risk mitigation measures that reduce the chances of exposing the user with the chemically active substances. Moreover, during the transfer of the liquid the avoidance of spillages is desirable as well. Further, in some industries contamination of the liquids is strictly forbidden, like for example in food and beverage industries. Therefore, closed transfer systems (CTS) have been suggested for transporting liquids from a container into e.g. other receptacles or systems. However, the currently known systems are only available for large multi-trip containers or cause high costs due to the employment of complicated valve technology within the dispensing device of such closed transfer system. The opening and closure mechanism are also based on the application of metal springs which are necessarily needed for the activation and operation of the employed valves. Due to the high costs of such spring based opening- and closing-mechanisms, these opening and closure mechanisms are normally provided within the centrally used dispensing device, which is used for a plurality of different containers. Providing a container with a permanent cap that comprises such an expensive, metal spring based opening- and closing-mechanism is economically not desirable as the containers are used only once. Moreover, the container is not easily recycled if it comprises a metal spring. Therefore, the currently used containers merely comprise an opening with a one-time seal, e.g. a seal foil, on top of which an ordinary screw cap is provided. For draining the container it is thus necessary to first remove the ordinary cap and to subsequently remove the seal or to puncture, i.e. to pierce, the seal foil with the dispensing device which comprises the closure mechanism. Hence, after decoupling the dispensing device the seal foil is attached to the container opening in a destroyed configuration and no automatic closure of the opening of the container is provided after decoupling the dispensing device. However, such a situation disadvantageously bares the risk of both contamination and leakage. Further, an unintentional decoupling during the process of draining may cause large spillages and may create an additional operator risk.

In the state of the art, probes with extraction apertures are used which are closed by means of sealed and sliding sleeves which are only actuated by springs. However, the inventors of the present invention found that it may be the case that the movement of the sleeves can be incomplete due to an increase in friction or failure of the spring to overcome the friction leaving the probes open while the coupling device is removed from the cap and the container. This may allow liquid to escape which in turn increases potential contamination of the operator.

### SUMMARY OF THE INVENTION

There may be a need for an improved coupling between such coupling devices and the cap of the container. It may be seen as an object of the present invention to provide for an improved coupling between such coupling devices and the cap of the container.

The object is solved by the subject matter of the independent claims. Further aspects, embodiments and advantages of the present invention are comprised by the dependent claims. The following detailed description of the present invention similarly pertains to the coupling device, the system for draining and venting a container and the method of mechanically coupling the coupling device to the container. In other words, synergetic effects may arise from different combinations of the embodiments although they may not be described hereinafter explicitly. The features of different embodiments can be combined unless explicitly stated otherwise hereinafter. Moreover, any reference signs in the claims should not be construed as limiting the scope of the claims. The method described herein may also be carried out in an order of steps that is different than the order explicitly mentioned herein, unless explicitly stated to contrary herein.

Before the invention is described in detail with respect to some of its preferred embodiments, the following general definitions are provided.

The present invention is illustratively described in the following and may be suitably practiced in the absence of any element or any elements, limitation or limitations not specifically disclosed herein.

The present invention will be described with respect to particular embodiments and with reference to certain Figures, but the invention is not limited thereto, but only by the claims.

Wherever the term “comprising” is used in the present description and claims it does not exclude other elements. For the purpose of the present invention the term “consisting of” is considered to be a preferred embodiment of the term “comprising of”. If hereinafter a group is defined to comprise at least a certain number of embodiments, this is also to be understood to disclose a group which preferably consists only of these embodiments.

Where an indefinite or definite article is used when referring to a singular noun, e. g. “a”, “an”, or “the”, this includes a plurality of that noun, unless something else is specifically stated hereinafter. The terms “about” or “approximately” in the context of the present invention denote an interval of accuracy that the person skilled in the art will understand to still ensure the technical effect of the feature in question. The term “typically” indicates deviation from the indicated numerical value of plus/minus 20 percent, preferably plus/minus 15 percent, more preferably plus/minus 10 percent, and even more preferably plus/minus 5 percent. Technical terms are used herein by their common sense. If a specific meaning is conveyed to certain terms, definitions of terms will be given in the following in the context of which the terms are used.

The term “cap” as used herein shall be understood as a sealing cap and/or as a cap for closing the inlet of the container. Different attachment means may be used for attaching the cap to the inlet opening of the container or to the neck where the inlet opening is positioned. For example, an internal thread or an external thread comprised by the cap may be used to engage the cap with the inlet opening which may comprise a corresponding counter-thread. However, other attachment means, like for example a click and snap closure or a fixation of the cap at the container with glue, may be used for attaching the cap to the container.

Moreover, the term “shoulder” shall be understood as any kind of shape or contour of the sidewall which facilitates the desired engagement with at least a part of the respective closure insert. Particularly, a shoulder may be embodied as a protrusion which extends from the sidewall of an opening of the cap such that a counterpart of the corresponding closure insert can engage with the shoulder in fluid tight manner when the shoulder and the closure insert are pushed or pressed towards each other. Different embodiments and more details about said shoulders will be provided hereinafter.

Furthermore, although the working principle and some embodiments of the present invention are described in combination with a liquid in the container, also solid state materials, or gases, or in any combination thereof, can be stored in the container without departing from the present invention The liquid and may also be comprised in the container in pure form or in combination with different materials like a solvent or several solvents. Further, the adjuvant may be comprised by the container in pure form or in a combination with a liquid. For example, a plant protection chemical or a plant protection adjuvant or a combination thereof may be the liquid in the container of the present invention.

The term “closure insert” as used herein shall be understood as a plug or a stuff that can be inserted into the cap by inserting it into an opening of the cap. The closure insert, when in its inserted position and when engaging with the shoulder in a fluid tight manner, realizes releasably one of the two closing functions of the cap. The closure insert may have essentially the same diameter as the corresponding opening of the cap. More technical details about these closure inserts as used in the context of the present invention will be described hereinafter. The closure insert may comprise a sealing ring or other sealing elements so as to releasably seal one of the openings of the cap. Different materials may be used, but, as will be explained in detail, materials resistant to the used liquid are preferred. Specific embodiments of said materials for the sealing plugs, i.e. the closure inserts, are presented hereinafter. In particular, the closure inserts or plugs in the cap may have a spring function derived from a material memory in the legs of the plug and this is used to retain the plugs in position and sealed.

It should be noted, that in the context of the present invention the term “distal” is used in the following sense. A movement of the probes in distal direction is to be understood as a movement towards the cap and towards the bottom of the container on which the cap is provided. FIG. 2 shows a distal direction by arrow 202. As a consequence, the proximal direction as used herein is understood to be opposite of said distal direction. Therefore, a “proximal” movement of the probes is to be understood herein as a movement away from the container bottom, away from the cap and thus opposite of the arrow 202 shown in FIG. 2.

According to an exemplary embodiment of the invention, a coupling device configured to be mechanically coupled to a springless cap of a container to be in a coupled configuration is presented. The springless cap may be seen as a container closure. The coupling device comprises a first probe configured to be inserted into a first opening of the cap and comprises a second probe configured to be inserted into a second opening of the cap. The coupling device further comprises a first sleeve configured to cover a first extraction aperture of the first probe and a second sleeve configured to cover a second extraction aperture of the second probe. The first sleeve is slideably attached to the first probe and the second sleeve is slideably attached to the second probe. The coupling device is configured, when in the coupled configuration, to disengage a first closure insert of the cap from a first shoulder of the cap by axially pushing the first closure insert with the first probe. The coupling device is also configured, when in the coupled configuration, to disengage a second closure insert of the cap from a second shoulder of the cap by axially pushing the second closure insert with the second probe.

It should be noted that the extraction aperture can also be used for delivering liquid or other media to the container, i.e, the use of this aperture is not limited by the name extraction aperture for extraction purposes only.

In principle, the use of the coupling device of the present invention can be defined as follows. First, the coupler can be fixed at the cap. Subsequently, the sleeves or the sleeves and the probes are inserted into the cap. Further subsequently, the probes are connected with the closure inserts. Furthermore, the closure inserts are dislodged or uncoupled from the cap and are coupled with the respective probe and are inserted by the probes into the container. This situation can be gathered from for example FIG. 4. The fixation of the probes in this extraction position can be carried out. This sequence is reversed in order to disconnect the coupling device from the cap. Details and embodiments about this coupling and decoupling process will be described in more detail in the following.

It should be noted, that the coupling device of the present invention can be used in combination with rigid containers and also with flexible containers. Furthermore, the coupling device may comprise springs in order to at least partially or completely actuate the movement of the sliding sleeves of the respective probe. In case such springs are used, they are applied for supporting the movement of the sleeves which is caused by the user when pushing or pulling parts of the coupling device. However, according to a specific embodiment, the coupling device may also be embodied springless, i.e., free of springs. Different lengths and geometrical dimensions can be chosen according to the desired purpose of the coupling device and can be selected by the user.

In case the coupling device comprises springs for the movement of the respective sleeve, the following should be noted. A first spring exerting a force onto the first sleeve forcing the first sleeve towards a position in which the first extraction aperture is covered by the first sleeve may be comprised by the coupling device. Furthermore, a second spring may be comprised by the coupling device, wherein the second spring exerts a force onto the second sleeve forcing the second sleeve towards a position in which the second extraction aperture is covered by the second sleeve. Furthermore, the first probe may also comprise a first inner channel which is connected to the first extraction aperture and the second probe may comprise a second inner channel which is connected to the second extraction aperture.

Advantageously, a secure and reliable connection between the coupling device and the container can be achieved. For example the locking means at the cap can be provided, which interact and are engageable with a locking interface of the coupling device in an exemplary embodiment. This locking interface at the coupling device and the locking means at the cap will be described in more detail hereinafter. The locking interface may be embodied as a separate component. The coupling device may also be embodied as a single component in which the locking interface is provided. More details are disclosed in this respect hereinafter.

The provided coupling device allows for draining the liquid via one of the openings of the cap and allows for venting the container simultaneously via the other opening of the cap. Advantageously, also rigid containers, even large sized ones, can be used due to the venting function provided by the dual function closure of the container and the cap in combination with the coupling device. In other words, a coupling device with a dual function closure is presented which facilitates draining and venting the container. Advantageously, the cap can be permanently fixed to the container, i.e. before, during and after draining, venting and/or washing the container. Said steps of draining, venting and/or washing shall be understood to be part of an embodiment of the present invention. Further, such a coupling device facilitates that upon disconnecting the coupling device from a container an automatic resealing of the container is triggered or caused. Thus, the coupling device of the present invention facilitates that the container is rendered back to a safe state without exposure or spillage as soon as the coupling device is removed. The container as presented herein facilitates the provision and use of a valuable closed transfer system for transferring the liquid from the container. Moreover, this embodiment of the invention provides for a reliable, single material and low cost closing mechanism which is permanently fixed at the container. These aspects and functionalities of the coupling device and of the container will be described and elucidated in more detail hereinafter.

The dual function permits an easy use for the operator and is available at simple and low cost construction. A direct and clean connection can be established between the container (comprising the springless cap) and a device, for example a crop protection spray system. The coupling device of the present invention, as disclosed hereinafter in more detail, can be used for this purpose. The risk of operator exposure to the concentrate can be reduced compared to current practices with standard containers, which will become apparent form the following explanations. The presented container provides for connectivity without using complex devices in the closure that are difficult to recover or reduce the capacity for post use recycling. Hence, the provided container reduces the complexity of the closure system and at the same time provides for a recyclable container comprising the springless cap. The coupling device of the present invention allows for a passage of liquid from the container and allows for a simultaneous passage of air into the container through the first and second openings. Further, rinsing water can be guided into the container and rinsate can be guided simultaneously out of the container using the two connection points, i.e. the first and the second probes of the coupling device. If the requirement for closed transfer is mandated or enforced through other regulatory controls the cap can be permanently attached to the container preventing any use except through a closed transfer system but which is an unavoidable engineered safety solution.

Opening the container and transfer with a closed transfer system can be followed by re-closure of the container and storage for later use while maintaining the minimal exposure risk. The closure technique provided by the cap eliminates the current barrier between safe techniques for small and large packs and reduces the end users requirement for equipment to just one coupling device, the coupling device of the present invention. The functionality of a releasable, fluid tight engagement between the closure inserts and the surrounding walls of the openings of the cap may be seen as a valve function, which will be described hereinafter by different embodiments.

According to this embodiment of the present invention the coupling device is used together with a cap which is provided in a springless form. Therefore, the cap does not comprise a spring, particularly not a metal spring. Thus, a metal free container and a metal free cap, which is permanently fixed on the container, can be provided. This increases the acceptability of the container (including the cap) for recycling. Moreover, the engagement between the closure inserts and the respective shoulders of the cap walls may be seen as a valve or as providing for a valve function. In other words, the cap comprises a fluid tight closing and opening valve mechanism which works without using a spring in the cap. Therefore, the first and second openings, the first and second closure inserts, the first and second circumferential walls, the first and second shoulders and the engagement between the shoulders and the closure inserts respectively, are providing a springless valve or valve function. However, this does not exclude that other parts, like a coupling device which is embodied separately from the cap, may make use of a spring. The container with the permanently fixed cap is spring free and thus facilitates a metal free, single material solution. Therefore, the cap with its first and second (or even more) closure inserts is embodied as a fluid tight, springless closure system for closing the container and opening the container. If desired, the springless cap in this and every other embodiment mentioned herein can additionally be embodied as an elastomer free cap. This may be embodied as a single material container and cap configuration.

As will become apparent from the following explanations, the first and second closure inserts are moveable within the respective opening of the cap by using the coupling device of the present invention. Such a moveability of both closure insert is used to fluid tightly close and seal the openings of the cap and to re-open said openings of the cap by using the coupling device of the present invention. A forth and back movement of the first and second closure inserts within the cap can be achieved by pushing and/or pulling the inserts along the axial, i.e., longitudinal direction of the corresponding opening. Said axial direction may be seen as the longitudinal direction of the cap along which the openings extend. In the Figures this axis is shown with reference sign 202. Said pushing and pulling is accomplished by pushing and pulling of corresponding probes of the coupling device. The achieved movement of the closure inserts represents the transfer of the container from an open configuration to a fluid tightly re-sealable closed configuration, and vice versa. This mechanism can be operated or activated repeatedly to an unlimited extent. During the open configuration the inserts are attached to/engaged with the probes of the coupling device, see for example the details explained for FIG. 4.

Furthermore, it should be noted that the first probe and the second probe can be immovably attached to a coupler body of the coupling device. Such a configuration will be described hereinafter in more detail with respect to specific embodiments of the present invention.

According to another exemplary embodiment of the present invention, the coupling device is configured to block the first and the second sleeves at a first predetermined longitudinal position thereby preventing a translational movement of the first and second sleeves in proximal direction. The first and second probes are in a second predetermined longitudinal position when the first and second sleeves are in the first predetermined longitudinal position. Furthermore, the coupling device is configured to allow a further translational movement of the first and second probes from said second predetermined longitudinal position in distal direction only when the first and second sleeves are blocked at the first predetermined longitudinal position.

Advantageously, this embodiment of the coupling device ensures that the fluid tight connection established before the probes engage with the closure inserts of the cap and thus open the container. This embodiment describes an alternative or additional functionality of the coupling device that can be combined with any other functionality of the coupling device described hereinbefore and hereinafter.

As defined before a distal movement of the probes is to be understood as a movement towards the cap and towards the bottom of the container at which the cap is provided. FIG. 2 shows a distal direction by arrow 202. Therefore, a proximal movement of the probes is to be understood herein as a movement away from the container bottom, away from the cap and thus opposite of the arrow 202 shown in FIG. 2. Further, it should be noted that due to possibly different spatial dimensions of the probes and the sleeves, the first predetermined longitudinal position and second predetermined longitudinal position are used for the general definition of this embodiment. However, it is also possible that the probes are positioned at the same longitudinal position as the sleeves when the sleeves are in the first predetermined longitudinal position such that the first and second predetermined longitudinal positions are the same. However, in general, the probes are in the second predetermined longitudinal position when the sleeves are in the first predetermined longitudinal position.

The coupling device of this embodiment ensures that the probes of the coupling device can engage with the respective closure insert of the cap only when the sleeves are blocked in the first predetermined longitudinal position with respect to a proximal movement. Advantageously, this first predetermined longitudinal position is the position of the sleeves in which they sealably, i.e., fluid tightly, engage with the cap such that a fluid tight connection between the coupling device and the openings of the cap is established. Sealing means at the cap and/or at the sleeves may be used for this purpose as disclosed herein in the context of exemplary embodiments. Only when the sleeves are blocked by the coupling device in this first predetermined longitudinal position, the coupling device facilitates a further distal movement of the first and second probes such that they can approach the first and second closure inserts of the cap in order to open the openings of the cap for e.g. draining and venting the container. Therefore, the coupling device of this embodiment may be understood to provide a probe translation control mechanism which depends on the position of the first and second sleeves. The gist and working principle of this probe translation control mechanism will be explained in more detail in the following.

The coupling device of the present invention is typically positioned onto the cap of the container. If desired, a locking mechanism may be activated such that the coupling device is fixed at the cap of the container in order to prevent an unintentional removal of the coupling device from the cap. Different locking means and/or a locking interface of the coupling device and locking means at the cap may be provided as such a locking mechanism. After locking the coupling device to the cap of the container, the probes and the sleeves can be moved by for example a translation or by a combined translation and rotation of specific components of the coupling device towards the cap. During this movement, the sleeves and probes approach the first predetermined longitudinal position. In a specific embodiment, the sleeves comprise sealing means like for example an O-ring, respectively, which establish a fluid tight engagement between the sleeves and the respective part of the opening of the cap. Such a fluid tight engagement of the sleeves with for example the circumferential wall of the opening of the cap defines the first predetermined longitudinal position. In this position, the coupling device can block the first and second sleeves in proximal direction such that the fluid tight engagement cannot be released unintentionally. Different blocking mechanisms may be used with the coupling device in order to achieve this prevention. Protrusions or pins may be used which are directly or indirectly connected to the sleeves and which may abut against a component of the coupling device such that a proximal translation of the sleeves is prevented. Such a component may be a blocker or a means for abutment against which the protrusion or pin connected to the sleeves abut when the sleeves are blocked in this first predetermined longitudinal position. As a non-limiting example FIG. 10 shows a plate 1001 with a plurality of protrusions 1002, which protrusions 1002 engage with the distal wall of first transversal section 907 of the guiding track 906 as shown in FIG. 9. The first and second sleeves are attached in the assembled configuration to the sleeve plate 1001. The blocking mechanism of FIG. 9 is activated and deactivated by a rotation of the coupler jacket relative to the coupler body caused by the user as explained in the context of FIGS. 9 to 11. Although this embodiment is described by means of the non-limiting embodiment of FIG. 9, the same functionality is also provided by the embodiment of FIG. 15 and is also provided by the embodiment of FIG. 18 which will be described in detail hereinafter.

However, also other mechanical and/or electronic means may be used in order to block and unblock the first and second sleeves at this position. For example the blocking may be released by pushing a knob which then releases blocking of the first and second sleeves in the first predetermined longitudinal position. Further, for blocking the sleeves, an optical or magnetic detector may detect when the first and second sleeves are in the first predetermined longitudinal position and may cause protrusions to engage with a stopper or with an abutment means to cause the blocking. This may be caused automatically and by using electrical signals. However, also a purely mechanical mechanism may be used in the coupling device, as for example shown in the embodiment of FIGS. 9 and 10. The same holds true for other blocking mechanisms described herein, particularly for the blocking of the probes in distal direction during the decoupling process as described later on.

In one non restricting embodiment, rotating a first part of the coupling device relative to a second part of the coupling device, the protrusions or pins 1002 may be brought into the desired engagement with the first transversal section 907. In the exemplary embodiment shown in FIGS. 9 and 10, the probes 911 and 918 can only be pushed further forward towards the cap 902 when the first protrusion is within this section 907, i.e., after a rotation has been caused to bring the protrusion into this section. In addition, the coupling device allows in this situation to keep the first and second sleeves blocked and to decouple the movement of the first and second probes from this blocking of the sleeves. Alternatively, also other mechanisms may be used in order to decouple the movement of the first and second probes from the blocked configuration of the first and second sleeves.

In the mechanical embodiment shown and explained in the context of FIGS. 9 and 10, a further rotation of the coupler jacket with respect to the coupler body causes the protrusions 1108 as shown in FIG. 11 to move from second transversal section 1015 of second guiding track 1003 into the vertical section 1014 of this second guiding track. As a consequence, a further translational movement of the first and second probes is then allowed while simultaneously the first and second sleeves are still blocked at the first predetermined longitudinal position, i.e., in a fluid tight engagement with the cap, as the first protrusion 1002 is still blocked in proximal direction by the first vertical section 907 of the first guiding track 906. As has been described before, of course also other mechanisms for blocking the movement of the sleeves and for allowing further distal movement of the probes can be used without departing from the scope of this embodiment.

Advantageously, mechanical or electrical actuation of the sleeves using an external force ensures a positive opening and closing of the probes so that the system is inherently safe for connection and disconnection without relying on sleeve to probe friction or the spring pressure available. In other words, the interlocked actuation of the probes and sleeves as has been described that ensures the correct sequence of probe and sleeve positions so that operator exposure is minimized. Less force may be necessary to couple the cap. Furthermore, a positive engagement and sequencing of the probes and sleeve can be ensured by the mechanism as described before. Also the safety of the coupling device is increased as leakages are avoided. Furthermore, in case a locking mechanism as described before is used, an unintended disconnection is also avoided.

According to another exemplary embodiment of the present invention, the sleeves close the extraction apertures of the corresponding probes, respectively, when the probes are in the second predetermined longitudinal position and the sleeves are in the first predetermined longitudinal position.

According to another exemplary embodiment of the present invention, the coupling device comprises a coupler body and a coupler jacket. Furthermore, the coupling device is configured to block the first and the second sleeves in proximal direction at the first predetermined longitudinal position when the coupler body and the coupler jacket are rotated relative to each other.

Both the coupler body and the coupler jacket may consist of and comprise several components. In particular, the coupler jacket may comprise several tubular components as will be described in more detail hereinafter. However, also other mechanical and/or electrical components may be used to provide a coupler and its respective functions as has been described and as will be described hereinafter in more detail.

Different embodiments of coupler bodies and coupler jackets will be described hereinafter in more detail. In principle, the coupler jacket may surround the coupler body and vice versa. As has been described before, a rotation that is caused by the user between the coupler body and the coupler jacket activates at least the first blocking mechanism described before such that the first and second sleeves cannot move anymore into the proximal direction. This may ensure that the fluid tight engagement between the sleeves and the cap is not disconnected. This rotation may be clockwise or may also be counter-clockwise. As will be explained in more detail with respect to the embodiments shown in FIGS. 9 to 11 and the embodiment of FIG. 15 and the embodiment of FIG. 18, a rotation is a convenient way of activating or deactivating any of the blocking mechanisms of the coupling device describe herein.

According to another exemplary embodiment of the present invention, the coupler jacket comprises a first guiding track, wherein the first guiding track has a first transversal section, a second transversal section and a longitudinal section or helical section. The coupler body comprises a first protrusion that engages with the first guiding track of the coupler jacket. The blocking of the first and second sleeves at the first predetermined longitudinal position in proximal direction is defined by an engagement of the first protrusion with the first transversal section of the first guiding track.

Of course a plurality of protrusions and a plurality of guiding tracks can be used which fulfil the same, corresponding functionality. This is also shown in some Figures.

A first transversal section can be understood as a distal transversal section which means a transversal section at the distal end of the guiding track. This holds true for the first and for the second guiding track. As a consequence, a second transversal section may be understood as a proximal transversal section which means a transversal section at the proximal end of the guiding track. This also holds true for the second guiding track. The second transversal section of the first guiding track may be used to block the initial translational movement of the coupler body from the proximal end position. Such proximal end position is exemplarily shown in the exemplary embodiment of FIG. 13. The proximal end position is referenced by reference sign 1313. The first guiding track may be seen as a Z guiding track as it may have the general shape of a Z. The guiding track may be seen as a recession or deepening in the respective component of the coupler jacket into which a pin or a protrusion may engage in order to provide for the desired function. In particular, a blocking function in the sense of preventing a movement of an attached component can be provided by using a guiding track and an engaging protrusion.

In principle, a guiding track in the context of the present invention guides a movement of the coupler jacket relative to the coupler body during the coupling procedure by means of which the coupling device is connected to the cap. Different shapes and different sections may be provided by the guiding tracks of the present invention, they may for example have a Z shape or an L shape as can be gathered from the embodiments of the figures.

Such a first guiding track as comprised in the embodiment of the present invention can be combined with another guiding track in order to provide additional functionalities. The movement 1807 shown and explained in the context of FIG. 18 is realized by applying at least one guiding track within the coupling device. The movement path shown in FIG. 18 may be realized by translating and/or rotating the coupler body and the coupler jacket with respect to each other at different positions.

According to another exemplary embodiment of the present invention, coupler body and the coupler jacket are configured to move relative to each other by a translational movement and/or by a rotational movement. The coupler body is movable relative to the coupler jacket from a proximal end position to a distal end position. The coupling device is configured to block the translational movement of the coupler body from the proximal end position in distal direction when the coupler jacket is in a first rotational position relative to the coupler body. Furthermore, the coupling device is configured to allow the translational movement of the coupler body from the proximal end position in distal direction when the coupler jacket is in a second rotational position relative to the coupler body.

The working principle and functionality of this embodiment can be gathered from the exemplary embodiment shown within FIGS. 9 to 11. With respect to the proximal end position and the distal end position it is referred to the embodiment of FIGS. 13 and 14 where the proximal end position 1313 and the distal end position 1403 are depicted. In the proximal end position, i.e., the starting position when starting the coupling process, the protrusion or protrusions 1002 of sleeve plate 1001 is/are positioned in the second transversal section 908 and can be brought into the vertical section 909 by rotating the coupler jacket relative to the coupler body. A translational movement from this proximal end position into a position which is in distal direction is allowed in this second rotational position. The first rotational position is to be seen as a situation where the engagement of the protrusion end section 908 prevents a translational movement.

It should be noted that the first protrusion of the coupler body in this and every other embodiment may be directly or indirectly coupled or attached to the first and second sleeves such that they move synchronously.

According to another exemplary embodiment of the present invention, the blocking of the translational movement of the coupler body from the proximal end position in distal direction is defined by an engagement of a first protrusion of the coupler body with a first guiding track of the coupler jacket. The first protrusion is positioned in the second transversal section of the first guiding track when the coupler jacket is in the first rotational position relative to the coupler body. The first protrusion is positioned in the longitudinal or helical section of the first guiding track when the coupler jacket is in the second rotational position relative to the coupler body.

According to another exemplary embodiment of the present invention, the coupling device is configured to allow for a synchronous translation in distal direction of the coupler body, the first and second probes and the first and second sleeves until the first protrusion abuts against the first transversal section of the first guiding track. In this position, the coupler body and the coupler jacket are rotatable relative to each other from a third rotational position to a fourth rotational position of the coupler jacket relative to the coupler body when the first protrusion abuts against the first transversal section. The first protrusion is positioned in the first transversal section of the guiding track when the coupler jacket is in the fourth rotational position relative to the coupler body wherein the coupling device is configured to allow a further translational movement in distal direction of the coupler body and the first and second probes when the coupler jacket is in the fourth rotational position relative to the coupler body.

This embodiment has been explained in detail before by means of a comparison with the embodiments shown in the figures. It should be noted that the second rotational position and the third rotational position in the embodiment shown in FIG. 9 are the same as the guiding track extends comprises a longitudinal section and not a helical or a partially helical section which would then lead to a difference between the second and the third rotational positions. However, both options are in principle possible according to this exemplary of the present invention.

According to another exemplary embodiment of the present invention, the coupling device is configured to block the first and the second probes in distal direction at the second predetermined longitudinal position thereby preventing a translational movement of the first and second probes in distal direction. The coupling device is configured to allow a translational movement of the first and second sleeves from the first predetermined longitudinal position and in proximal direction only when the first and second probes are blocked in distal direction at the second predetermined longitudinal position.

This embodiment is important for the decoupling process and ensures that before the sleeves and probes are finally pulled out of the cap the probes cannot move anymore in distal direction towards the cap. This embodiment describes an alternative or additional functionality of the coupling device that can be combined with any other functionality of the coupling device described hereinbefore and hereinafter.

The actuation of sleeves, solely with springs, does not in all cases ensure that the sleeves are correctly positioned to close the probe openings at the required stage of the operation. However, in this embodiment of the present invention it is ensured that the sleeves are correctly positioned during the process of removing the probes from the container and the cap, i.e., during the disconnecting process. This embodiment ensures that the probes cannot open prematurely or remain open when the coupler is disengaged from the cap. When the probes are in the second predetermined longitudinal position the sleeves close the extraction apertures of the corresponding probes, respectively. The probe sleeves movement is controlled by the external operation and movement of the coupler components action to disconnect the coupler ensures the complete closure of the probes before disconnection is completed. With external mechanical actuation, the exact position of the sleeves is guaranteed. Unintended leakage can advantageously be avoided. This embodiment also ensures that a decoupling of the coupling device from the cap can only be carried out when the sleeves are closed and when the insert closures of the cap are fluid tightly engaged with the cap, as the device can only be decoupled when the sleeves are removed from the first predetermined longitudinal position. It is ensured by this embodiment that the first and second sleeves can only be removed from the fluid tight engagement with the cap when the first and second probes are in a longitudinal position at which the closure inserts of the cap are repositioned at the cap and are disengaged from the probes such that the container is closed. Only when these criteria are fulfilled, the sleeves can be moved in proximal direction in order to further decouple the device from the cap. In an exemplary embodiment, this functionality of the coupling device is realized by the embodiment shown within FIGS. 9 to 11. However, the herein provided embodiment is not limited to the embodiment shown within FIGS. 9 and 11. When removing the first and second probes from the cap, the coupling body 1103 is moved in proximal direction with respect to the cap and the coupler jacket 1114. The plate 1107 which comprises protrusions 1108 is attached to the coupler body 1101 at the lower end shown in FIG. 11. These second protrusions 1108 can also be seen in FIG. 9 and are shown with reference sign 919 in FIG. 9.

The protrusions 919 which are immovably attached to the coupler body 903 are sliding in longitudinal recessions of the coupler jacket 904. Furthermore, these protrusions are sliding in and are engaging with the guiding track 1003 which is the second guiding track. When pulling the probes away from the cap to close the cap with the two closure inserts, these protrusions move in the longitudinal section 1014 until the probes abut against the sleeves such that they cannot be moved any further in proximal direction without releasing the mechanism that blocks the proximal movement of the first and second sleeves. In this position where the first and second probes abut against the first and second sleeves respectively, the protrusions 919 are in longitudinal section 114 at the proximal end such that upon a rotation, the protrusions 919 are engaging with the second transversal section 1015. In this position, the probes cannot be pushed anymore in distal direction towards the cap as they are blocked by the engagement with the vertically extending wall of the transversal section 1015. A further rotation may then cause that the first protrusion 1002 which engages first transversal section 907 of first guiding track 906 is brought into the longitudinal section 909. In this position, the coupling device allows a translational movement of the sleeves from the first predetermined longitudinal position and of the probes from the second predetermined longitudinal position in proximal direction. However, the first and second probes are still blocked in distal direction at this second predetermined longitudinal position. This blocking is achieved in this exemplary of the device of FIGS. 9 to 11 by the engagement of the second protrusions 919 with the second transversal section 1015. Of course also other mechanical and/or electrical blocking mechanism may be used by the person skilled in the art without departing from the scope of this embodiment.

According to another exemplary embodiment of the present invention, this coupling device comprises a coupler jacket and a coupler body and the coupling device is configured to block the first and the second probes in distal direction at the second predetermined longitudinal position when the coupler body and the coupler jacket are rotated relative to each other. This coupler body and the coupler jacket can be the same as has been described before in the context of a previous embodiment.

According to another exemplary embodiment of the present invention, the coupler jacket comprises a second guiding track wherein the second guiding track has a first transversal section, a second transversal section and a longitudinal or helical section. Furthermore, the coupler body comprises a second protrusion that engages with the second guiding track.

The same general explanations that are given herein for the first guiding track equally apply for the second guiding track. Also the second guiding track can have a Z-shape, an L-shape or another shape.

According to another exemplary embodiment of the present invention, the coupler body and the coupler jacket are rotatable relative to each other from a fifth rotational position to a sixth rotational position of the coupler jacket relative to the coupler body when the second protrusion abuts against the first transversal section of the second guiding track. In the sixth rotational position of the coupler jacket relative to the coupler body a translational movement of the coupler body, the first and second sleeves, and the first and second probes in distal and proximal direction are blocked.

For clarity reasons, this embodiment and its functionality is explained with respect to the embodiment shown in FIGS. 9 to 11. However, the same functionality is also provided by the embodiment of FIG. 15 and is also provided by the embodiment of FIG. 18 which will be described in detail hereinafter. The fifth rotational position may be seen as the position when the second protrusion 919 or 1108 are within the longitudinal section 1014. By means of a rotation, this protrusion can be brought into engagement with the slit-like transversal section 1013. In this position where the protrusion 919 engages with the section 1013, a complete blocking in proximal and distal direction of the coupler body, the probes and the sleeves is achieved. This may be seen as the position where the coupling device is securely locked to the cap and where the sleeves are fluid tightly engaged with the cap openings and where the probes have been inserted into the container thereby engaging respectively with the corresponding closure insert of the cap. The container is now in an open configuration. In order to reverse the movement of the coupler body, the probes and the sleeves, the engagement of the protrusion 919 with the transversal section 1013 has to be released.

According to another exemplary embodiment of the present invention, coupler jacket comprises a first tubular component and a second tubular component. The first tubular component surrounds the second tubular component and surrounds the coupler body. The second tubular component surrounds the coupler body. Exemplary components can be gathered from e.g. FIG. 11.

According to another exemplary embodiment of the present invention, the first tubular component comprises the first guiding track and the second tubular component comprises the second guiding track.

According to another exemplary embodiment of the present invention, the coupling device comprises locking interface, particularly at the coupler jacket, wherein the locking interface is configured for locking the coupling device with the cap of the container.

First of all, this embodiment allows a secure locking between the cap and the coupling device, such that an unintentional removal of the coupling device from the cap is avoided.

According to another exemplary embodiment of the present invention, the first and second probes are movable along a longitudinal direction relative to a coupler jacket of the coupling device from a proximal end position to a distal end position and vice versa. The first and second probes do not extend outside of the coupler jacket when positioned in the proximal end position.

As can be exemplarily shown from the embodiments depicted in FIGS. 13 and 14, the coupler jacket entirely surrounds the first and second probes when they are in the proximal end position.

According to another exemplary embodiment of the present invention, the first probe has a first length l₁, wherein the second probe has a second length 12 and wherein the first length l₁ of the first probe is different from the second length 12 of the second probe.

According to another exemplary embodiment of the present invention, the first extraction aperture is provide at a first height h₁, the second extraction aperture is provide at a second height h₂, and the first height h₁ of the first extraction aperture is different from the second height h₂ of the second extraction aperture.

In prior art devices, the opening for extraction and air/water inlet probes are enclosed in proximity to each other and the probes have the same length. This may have several disadvantages. With equal length probes that have equal height openings for extraction in one and air entry/rinsing in the other, it is possible, under some circumstances, to see incoming air move horizontally from the inlet probe and immediately into the extraction probe. This condition causes air to be entrained in the product, an imbalance of volume into the volume out resulting in internal pressure imbalance, deformation of the container and a reduction in extraction speed. It is also observed that equal length probes can result in an obstruction of the rinsing water that reduces effective container cleaning. These disadvantages are avoided by the exemplary embodiment presented herein. Providing different lengths of the probes such that the extraction apertures are provided at different heights avoids horizontal airflow, increases the measuring accuracy, improves the container cleaning, fastens the transfer of products and reduces the container deformation. Therefore, airflow shortcuts can be avoided. Providing the extraction aperture of the first probe at a second height compared to the extraction aperture of the second probe allows the incoming air to enter at a point that gravimetric forces cannot be overcome by the extraction flow and all air entering the container is directed to the head space to improve the container empting speed. The effective separation of liquid and air that is simultaneously achieved reduces the observed inaccuracy when measuring product transfers. The same additional height also positions the inlet openings where the incoming rinsing water can be distributed beyond the container neck features and above the extraction openings. This removes the shadowing effect and improves container rinsing. By avoiding direct air transfer emptying is faster and there is less deformation of the containers during emptying and rinsing and no interference with volumetric measuring devices is observed. The container can be rinsed more effectively.

According to another exemplary embodiment of the present invention, the coupling device is a springless coupling device.

According to another exemplary embodiment of the present invention, a system for draining and venting a container is provided. The system comprises a coupling device according any of embodiments presented herein and a container with a dual function closure, the container comprising a container body with at least one inlet opening and a springless cap for closing the inlet opening of the container body. The cap is attached to the inlet opening of the container body, wherein the cap comprises a first opening and a second opening. The cap comprises a first closure insert and a second closure insert, wherein the first opening is surrounded by a first circumferential wall. The first circumferential wall comprises a first shoulder, wherein the second opening is surrounded by a second circumferential wall. The second circumferential wall comprises a second shoulder, wherein the first closure insert releasably engages with the first shoulder such that the first opening is fluid tightly closed and wherein the second closure insert releasably engages with the second shoulder such that the second opening is fluid tightly closed.

The geometry of the cap with the circumferential walls and the interaction with the closure inserts has been described before and can also be gathered from the FIGS. 2 to 8b.

It should be noted, that in one embodiment the diameter of the first and second openings of the cap are the same, i.e. are of an identical size. The same holds true for the diameter of first and second closure inserts and of the first and second probes of the coupling device. In another embodiment, the diameter of the first opening and of the second opening are different and the diameter of the first closure insert and of the second closure insert are different. Corresponding differential sizing of the probes of the used coupling device, of the first and the second closure insert and of the first and second openings of the cap may be used to provide a mechanical lock-key connection when engaging the cap and the coupling device. This will be explained and specified in more detail hereinafter.

The cap and/or the container may be embodied in various ways regarding the material of the container body. For example, in case food or beverages are comprised by the container food specific materials coatings can be used. Moreover, in case the liquid is a liquid the following should be noted. There are liquids which are water-based and which are solvent-based liquids. In one embodiment the cap/container is provided with a barrier layer for solvents. In another embodiment, the cap/container does not comprise a barrier layer. Water based liquids can be used for example in HDPE mono material containers. For the use of solvent based liquids an inner layer containing polyamide or EVOH or a layer which is fluorinated can be comprised by the cap and/or the container. Moreover, the container/cap may comprise or consist of a wide range of polymers for example PET, Acytel used singularly or in combination or may comprise or consist of painted or varnished steel.

According to another exemplary embodiment of the invention a locking means is positioned at a top surface of the cap and the coupling device has a locking interface configured to engage with said locking means.

This embodiment may allow for an easy insertion of the probes into the cap and a simultaneous engagement of the locking means on the cap and the corresponding locking means on the locking interface of the coupling device. For example, the locking interface may be embodied as locking collar that is placed axially on the cap and is subsequently rotated around the two probes. In this way secure connection between the container and the coupling device is faciliated by the engaging connection between the cap and the locking interface.

According to another exemplary embodiment of the invention the locking means of the cap is embodied as a first protrusion, and the protrusion is configured to engage with a corresponding second protrusion of the coupling device.

The first and second protrusion may have various forms and thicknesses. They may be of the same material as the cap or the locking interface, but also other materials may be used for the protrusions. Further, such first protrusion and second protrusion may be embodied so as to form a claw-type coupling device, which is used to securely attach the coupling device to the container via the locking means of the cap.

According to another exemplary embodiment of the invention the locking means of the cap is configured as a first part of a bayonet mount for being engaged with a second part of the bayonet mount at the coupling device.

A bayonet mount is a device and method of mechanical attachment and may be seen as bayonet connector in a fastening mechanism. It may consist of a cylindrical male side with one or more radial pins, and a female receptor with matching L-shaped slot(s). If desired, one or more springs maybe used to keep the two parts locked together. The slots may be shaped, for example, like a capital letter L with serif, i.e. a short upward segment at the end of the horizontal arm. The pin slides into the vertical arm of the L, rotates across the horizontal arm, then is pushed slightly upwards into the short vertical “serif” by the spring. The connector is no longer free to rotate unless pushed down against the spring until the pin is out of the “serif”. This mechanical principle is applied, for example, in the embodiment shown in FIGS. 3a and 3b.

However, in this embodiment a protrusion 315 of the cap and the corresponding protrusion 316 of the locking collar provide for this bayonet mount functionality. Also other embodiments of the locking interface, here the locking collar or locking ring 302, and of the locking means at the cap are possible and comprised by the present invention. This will become apparent from and elucidated with further embodiments described herein.

According to another exemplary embodiment the locking means is embodied as an annular undercut that releasably engages with the locking interface of the coupling device.

According to another exemplary embodiment of the invention the first probe has a first diameter and the second probe has a second diameter, wherein the first and second diameters are different from each other.

This differentiation may be to determine the correct connection to the device or system and may also be used in a further embodiment to differentiate the connection between market segments, manufacturers, product groups or to determine a particular functionality. Providing the first and second probes with different diameters results in physically coding together with the first and the second opening which also have different diameters in the sense of a mechanical key. In other words, by means of the different diameters the first and second openings and the first and second probes determine the compatibility with respect to each other. Like a key-lock combination only a specific first probe can be inserted in the first opening whereas only a specific second probe can be inserted into the second opening of the cap. Therefore, an unambiguous assignment of each probe comprised by the coupling device to the respective opening of the cap is provided.

According to another exemplary embodiment of the present invention, the first sleeve is configured to fluid tightly engage with the first circumferential wall when the first sleeve is in the first predetermined longitudinal position and the second sleeve is configured to fluid tightly engage with the second circumferential wall when the second sleeve is in the first predetermined longitudinal position.

As has been described before, the coupling device of the present invention according to a specific embodiment can block the first and second sleeves in this position at least in distal direction but also in distal and proximal direction and the further movement of the probes in distal direction is decoupled from the sleeves such that they can be further translated towards the closure insert of the cap.

According to another exemplary embodiment of the present invention, the first and the second closure insert each engage with the corresponding shoulder such that upon axially pushing one of the closure inserts towards the bottom of the container body said closure insert disengages with the corresponding shoulder to be in a disengaged configuration and upon axially pulling said closure insert from the disengaged configuration and in a direction away from the bottom of the container body said closure insert re-engages with the corresponding shoulder such that the corresponding opening is again fluid tightly closed.

It should be noted that the previously described movement, caused by axially pushing and/or axially pulling, is disclosed herewith for the first closure insert and the second closure insert and the respectively engaging shoulders. In other words, each pair of a closure insert and the respective shoulder is configured to provide for a respective fluid tight engagement or seal within the respective opening of the cap. As will become apparent from the following figure descriptions the shoulders and the closure inserts are configured and/or shaped to provide for an engagement, which facilitates upon pushing and/or pulling the above described functions. Various contours and shapes of the engaging parts of the shoulders and the closure inserts are comprised by the present invention. To disengage the closure inserts with the respective wall of the cap the coupling device with the probes is used. The closure inserts may be engaged with the respective circumferential wall such that a first force is needed to push the closure inserts out of their respective engagement. Further, to engage the coupling front section of the respective probe with the corresponding closure insert a second force is needed. This second force can also be applied by pushing the two probes onto the two closure inserts. In a preferred embodiment, the first force is larger than the second force. Thus, when pushing the two probes onto the two closure inserts and when increasing the applied force, first the two closure inserts are engaged with the coupling front sections of the probes and subsequently, when further increasing the force, the closure inserts are pressed out of their engagement with the cap and the two openings of the cap are opened. The two closure inserts, the cap, i.e. the shoulders of the two openings, and the coupling front sections of the two probes are shaped such that this opening and closure mechanism is provided. Further details hereof are provided in the context of other embodiments, for example in the context of FIG. 7.

Furthermore, according to another exemplary embodiment of the present invention, the coupling device comprises a first component of a key lock mechanism and the cap provides a corresponding second component of the key lock mechanism.

In the prior art, an alignment of a coupler and the cap is dependent on hand and eye coordination and the internal parts cannot easily be viewed. In the prior art it is difficult to engage the coupler and the cap and they are not aligned properly and a small and long probe can dislodge a large plug unintentionally into the container leaving the bottle permanently open. This is avoided by the exemplary embodiment presented herein. The inclusion of for example a tapered and shaped key lock feature at the coupling device provides an intuitive and tactile method of positioning the cap and the coupler by simply rotating the coupler through just a few degrees in either direction. It enables the automatic alignment of cap and coupler during coupling process. A protrusion on the lower side of the coupler, which fits only in one orientation into a corresponding recess in the matching container closure, i.e., the cap, may determine a correct alignment. The protrusion drops into the recesses of the closure as soon as the protrusion, key, and recesses are aligned. Easy and quick engagement of coupler and closure makes the coupling process quicker and therefore saves the end user time. The vertical orientation of the coupler into the cap prevents a misuse and makes the equipment safer.

According to another exemplary embodiment of the present invention, the coupling device comprises a locking interface configured for locking the coupling device with the cap of the container, wherein the cap comprises a locking means adapted to engage with the locking interface of the coupling device, and wherein the locking interface and the locking means are configured to be locked together only in one rotational position of the coupling device relative to the cap. In other words, a key lock feature is provided by the system.

According to another exemplary embodiment of the present invention, the first closure insert comprises at least one radially deformable sidewall, wherein the second closure insert comprises at least one radially deformable sidewall, wherein the radially deformable sidewall of the first closure insert is adapted to releasably engage with the first shoulder, and wherein the radially deformable sidewall of the second closure insert is adapted to releasably engage with the second shoulder.

For example, elastic protrusions may be used as radially deformable sidewalls. Additionally or alternatively, sidewalls that are shaped in form of a partial circle can be an embodiment. The necessary deflection in radial direction is provided by the radially deformable sidewalls of the closure inserts. Moreover, if desired, recesses can be provided in, for example, a circumferential sidewall of the closure inserts, respectively, such that the remaining parts or sections of the circumferential sidewall provide for the desired ability to be elastically deflectable in a radial direction. Such a deflection can be caused upon an axial movement of the closure insert as has been described before and will be specified in more detail hereinafter. It should be noted that, in general, axial movements relate to movements along the axis shown with reference sign 202 whereas the radial direction is a direction extending perpendicularly to said axis 202. Axis 202 extends along the longitudinal axis of the openings of the cap, as can be gathered from e.g. FIG. 2. Moreover, during the transfer the liquid flows, more or less, along the direction indicated by axis 202. More details about the flow through one or more openings of the cap and through the probes of the coupling device will be given hereinafter.

According to another exemplary embodiment of the present invention, a method of mechanically coupling a coupling device to a cap of a container is presented. The method comprises the steps of providing for the container having a container body, the container body comprises at least one inlet opening and a springless cap attached to the inlet opening closing the inlet opening. The cap comprises a first opening, a second opening, a first closure insert and a second closure insert. The first opening is surrounded by a first circumferential wall and the first circumferential wall comprises a first shoulder. The second opening is surrounded by a second circumferential wall and the second circumferential wall comprises a second shoulder. The first closure insert releasably engages with the first shoulder such that the first opening is fluid tightly closed and the second closure insert releasably engages with the second shoulder such that the second opening is fluid tightly closed. The method further comprises the step of coupling the container via the springless cap with the coupling device thereby inserting a first probe of the coupling device into the first opening of the cap and inserting a second probe of the coupling device into the second opening of the cap. Furthermore, the step of disengaging the first closure insert and the first shoulder by axially pushing the first closure insert by the first probe is comprised and/or disengaging the second closure insert and the second shoulder by axially pushing the second closure insert by the second probe is comprised.

According to another exemplary embodiment of the present invention, the method further comprises the steps of blocking a first sleeve and a second sleeve of the coupling device at a first predetermined longitudinal position thereby preventing a translational movement of the first and second sleeves in proximal direction. The first and second probes are in a second predetermined longitudinal position when the first and second sleeves are in the first predetermined longitudinal position. Furthermore, the step of allowing a further translational movement of the first and second probes from said second predetermined longitudinal position in distal direction only when the first and second sleeves are blocked at the first predetermined longitudinal position is comprised.

According to another exemplary embodiment of the present invention, the method further comprises the steps of blocking the first and the second probes in distal direction at the second predetermined longitudinal position thereby preventing a translational movement of the first and second probes in distal direction. Furthermore, the step of allowing a translational movement of the first and second sleeves from the first predetermined longitudinal position and in proximal direction only when the first and second probes are blocked in distal direction at the second predetermined longitudinal position is comprised.

The method steps as have been described before can be carried out by any of the coupling device shown and presented herein.

These and other features of the invention will become apparent from and elucidated with reference to the embodiments described hereinafter.

### BRIEF DESCRIPTION OF THE DRAWINGS

Exemplary embodiments of the invention will be described in the following drawings.

FIG. 1 schematically shows a container, a cap and a coupling device according to an exemplary embodiment of the invention.

FIG. 2 shows a cross section of a cap as used in an exemplary embodiment of the invention.

FIGS. 3a and 3b schematically show a cap with a coupling device in accordance with an exemplary embodiment of the invention.

FIG. 4 schematically shows a cap coupled to a coupling device, a first and a second closure insert which are engaged with the first and second probes of the coupling device according to an exemplary embodiment of the invention.

FIG. 5 schematically shows a tamper evident cap in accordance with an exemplary embodiment of the invention.

FIG. 6 shows a cap with a tamper evident cap as used in accordance with an exemplary embodiment of the present invention.

FIG. 7 shows a cross section through a cap in which first and second closure inserts are inserted and into which first and second probes are introduced according to an exemplary embodiment of the invention.

FIGS. 8a and b schematically show the interaction between the first and second probes with first and second closure inserts according to an exemplary embodiment of the invention.

FIG. 9 schematically shows a coupling device according to an exemplary embodiment of the invention.

FIG. 10 schematically shows parts of the coupling device of FIG. 9.

FIG. 11 schematically shows parts of the coupling device of FIG. 9 in a disassembled configuration.

FIG. 12 schematically shows a coupling device according to an exemplary embodiment of the invention.

FIG. 13 schematically shows a coupling device according to an exemplary embodiment of the invention in the proximal end position.

FIG. 14 schematically shows the coupling device of FIG. 13 in the distal end position.

FIG. 15 schematically shows a coupling device according to an exemplary embodiment of the invention.

FIGS. 15a to 15d schematically show the coupling device or different components thereof from different views.

FIG. 16 schematically shows a system with a coupling device according to an exemplary embodiment of the invention.

FIG. 17 shows a flow diagram of a method according to an exemplary embodiment of the invention.

FIG. 18 schematically shows a coupling device according to an exemplary embodiment of the invention.

### DETAILED DESCRIPTION OF EMBODIMENTS

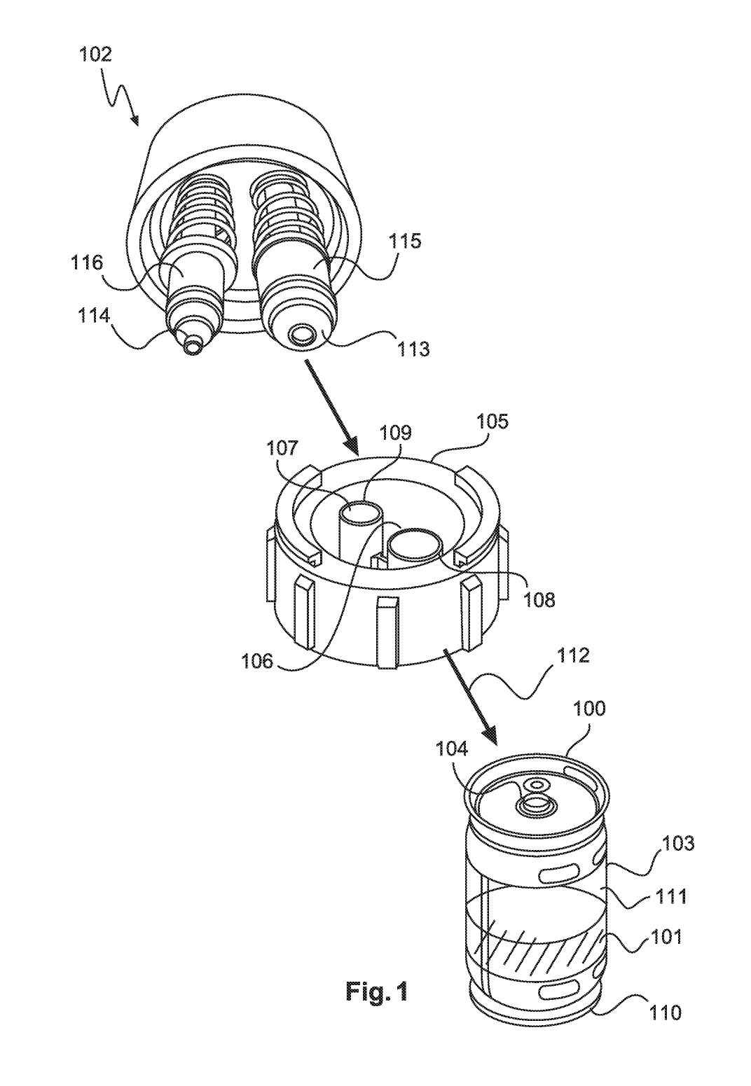

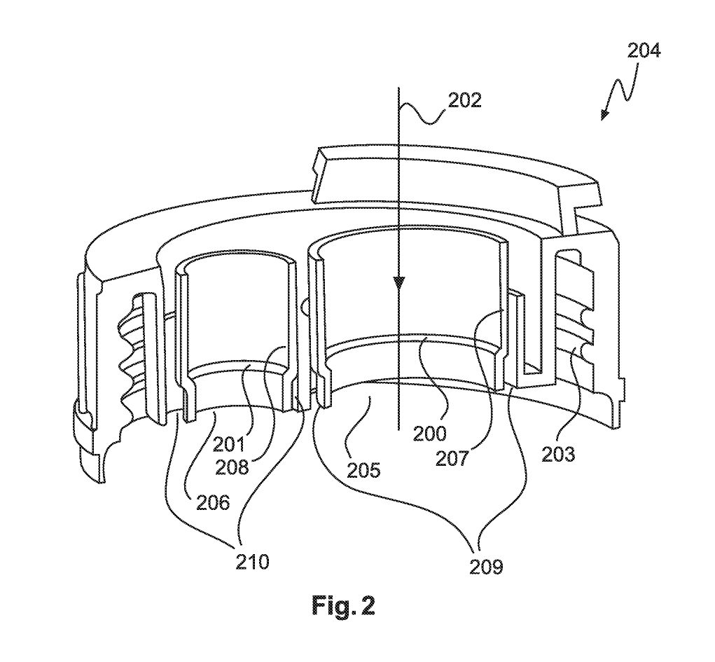

The embodiment of the coupling device of FIG. 1 also comprises a first probe 113 and a second probe 114 wherein the first probe comprises a first sleeve 115 and the second probe comprises a second sleeve 116. FIG. 1 further shows a container 100 for transporting and storing a liquid and with a dual functional closure. The container 100 of FIG. 1 comprises a container body 103 with at least one inlet opening 104. A springless cap 105 is shown which is configured to close the inlet opening of the container body. The cap 105 is embodied as a relatively low cost and disposable product. As illustrated by arrow 112 the cap can be attached to the inlet opening of the container body by appropriate attachment means. The cap 105 comprises a first opening 106 and a second opening 107 both extending vertically, i.e. in the direction from the top to the bottom of FIG. 1. This direction is termed axially and is precisely defined, in general, with respect to axis 202 of FIG. 2. In the first opening the first closure insert can be inserted and in the second opening a second closure insert can be inserted. However, due to illustrative reasons the first and second closure inserts are not shown in FIG. 1. Moreover, FIG. 1 shows a coupling device 102 which is configured to be coupled to the cap 105 via its two probes. The probes protrude protruding from a top surface of the coupling device. It should be noted that also other volumes may be used with the cap and with the coupling device shown in FIG. 1. Also other sizes and volumes are possible. In an exemplary embodiment that can be combined with the embodiment of FIG. 1 the cap 105 and the closure inserts are made of high density polyethylene (HDPE), fluorinated HDPE, polyamide, polyoxymethylene (POM), also known as acetal,[1] polyacetal and polyformaldehyde, or polyethylene terephthalate, or any combination thereof. Therefore, the system shown in FIG. 1 provides for a reliable and cheap closing mechanism which is permanently fixed at the container 100. The two probes shown at the coupling device 102 are surrounded by two sleeves which are attached movably such that the sleeves can be pushed along the longitudinal axis of the two probes. In such a situation, the two springs of the coupling device would be pressed to a compressed state. When inserting the coupling device 102 into the cap 105, such a movement of the two sleeves and such a compression of the two springs is realized.

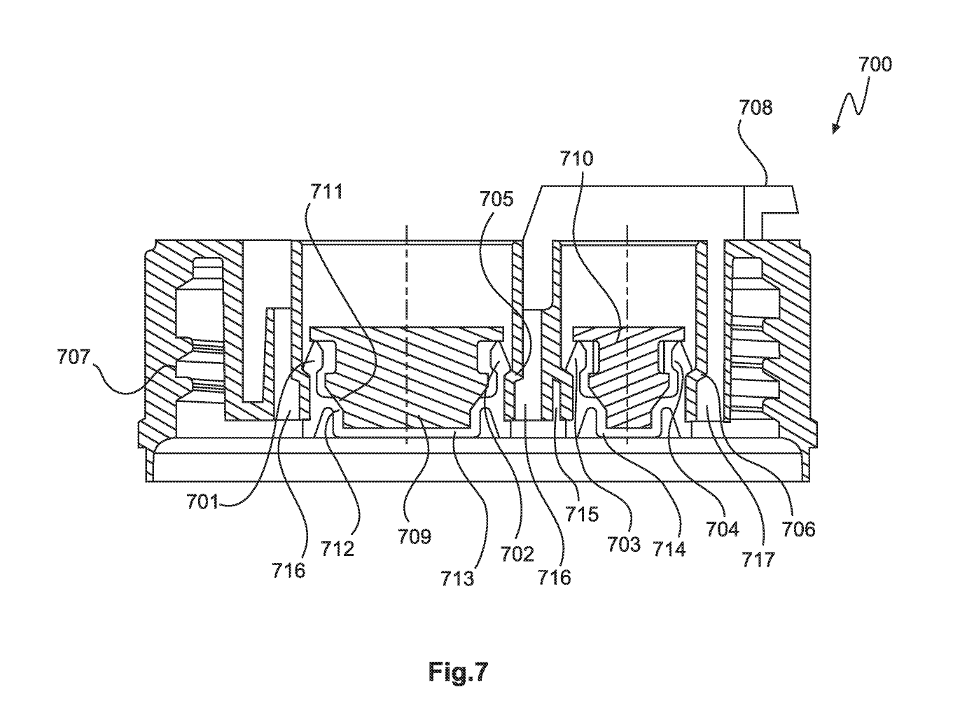

FIG. 2 shows a cap 204 as used in accordance with another exemplary embodiment of the present invention. Of course also other caps can be used. Cap 204 is embodied as a disposable product. FIG. 2 schematically shows a cross section through the cap 204 which is configured for closing the inlet opening of a container body of a container. The springless cap 204 comprises a first opening 205 having a first engagement shoulder 200 and also comprises a second opening 206 which comprises a second engagement shoulder 201. Axis 202 depicts the axial extension of the openings 205 and 206. Along this axis 202 probes or the coupling device may be introduced into the cap to make contact with the respective closure inserts that are then engaged at their position at the first and second shoulders 200 and 201. As can be seen from FIG. 2 the springless cap 204 comprises an internal thread that is configured to be threadedly and detachably engaged with a corresponding thread of the container. As can be seen in FIG. 2 the first and second shoulders 200 and 201 are circumferential shoulders protruding from the inner surfaces of the respective circumferential wall 207 and 208 of the openings. The first opening 205 has a first diameter which is distinguished from the diameter of the second opening 206. Therefore, a physically coding is presented which determines the ability of the respective opening of the cap with the probes of the coupling device. As will be explained in the following, the coupling device may also be seen as a dispensing device which facilitates dispensing the liquid from container via the opening of the cap. It should be noted, that the shoulder according to the present invention does not have to be a circumferential shoulder but can only be a protrusion that extends along partial sections of the circumferential wall 207 and 206 respectively. Moreover, if desired, the cap of FIG. 2 can also be embodied with two openings which have the same diameter. As can be gathered from FIG. 2 recessions or grooves 209 and 210 are provided in the cap, in particular behind the circumferential walls that engage with the closure inserts, such that said walls have an increased flexibility. Upon pressing the closure inserts out of the engagement with these walls, the walls may thus deflect outwardly. This aspect will also be described in detail in the context of FIG. 7.

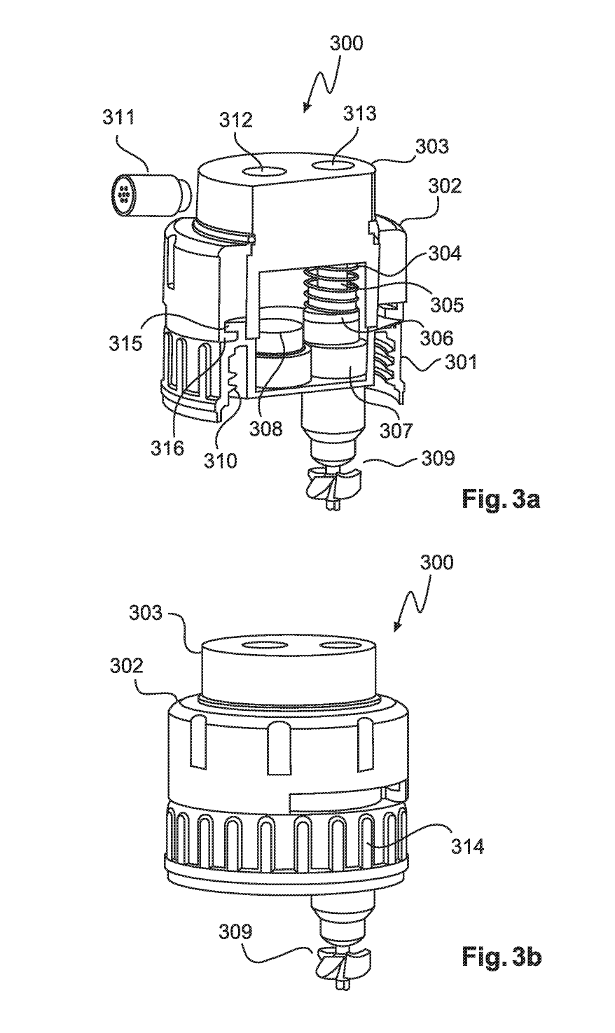

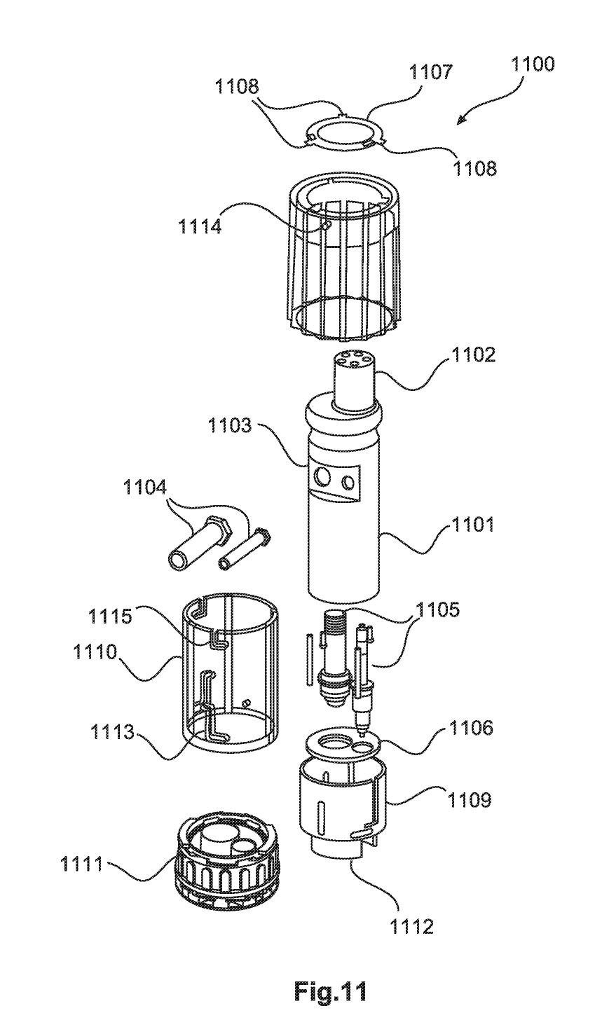

FIGS. 3a and 3b are two depictions of one system for draining and venting a container according to one exemplary embodiment of the present invention. In particular FIG. 3a shows a cross section through the system 300. On top of springless cap 301 the locking collar or locking ring 302 is positioned wherein the claw/protrusion 315 engages with the corresponding claw/protrusion 316 at the locking collar 302. Moreover a probe holder 303 is shown which comprises a first opening 312 and a second opening 313 in which the first and second probes can be inserted. Moreover, an air inlet valve 311 is schematically shown in FIG. 3a. Cap 301 comprises an internal thread 310 and can be screwed onto the neck of an inlet opening of a container. The second probe 305 is depicted in FIG. 3a and also a spring 304 which is part of the coupling device is shown. It should be noted, that the spring 304 is not needed and used for the mechanism for opening and closing the closure inserts in the first and second openings of the cap. Instead, spring 304 is used for pushing the sleeve 306 or jacket over the extraction apertures of the probe 304 as the spring exerts a force onto the sleeve. This mechanism will be described in more detail in the context of another embodiment, the embodiment of FIG. 11. Moreover, spring 304 improves the decoupling process. Consequently, due to the closure being automatically induced by the spring, no leaking water or crop protection chemical is spilled during the draining or filling process. Moreover, the user is protected from coming into contact with the parts which guide the liquid. However, for the procedure of disengaging or engaging the first and second closure inserts with the shoulders of the circumferential walls the spring 304 is not relevant and has no function. Therefore, the closing mechanism of provided by the cap is based on springless technology. Consequently also the cap 301 of FIGS. 3a and 3b is a springless cap. Moreover, housings 307 and 308 are shown and cap 301 comprises edges or protrusions 314 for providing a good grip for the user during screwing the cap onto the container. Further, a propeller 309 is shown, which is installed within the container and which can be driven by the incoming rinsing water and which distributes the water within the container during washing.

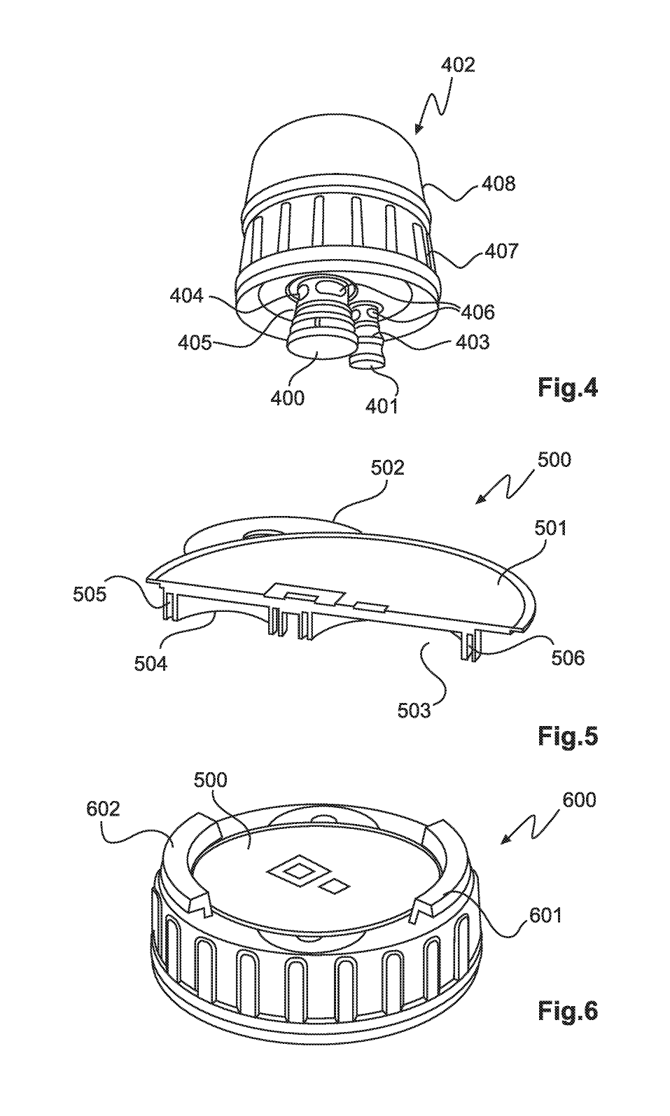

FIG. 4 schematically shows a disengaged configuration 402 of the first and second closure inserts 400 and 401 from the shoulder (not shown here) in the respective openings of cap 407. The cap 407 is coupled with the coupling device or dispensing device 408 such that the first probe 404 and the second probe 403 are extending through the cap 407 into the volume below the cap 407. Thus, in this situation the first and second openings of the cap are opened. As shown in FIG. 4 the coupled cap and coupling device are not attached to a container, however, in such an attached configuration the first and second probes 404 and 403 extend into the inner volume of the container. Due to the extraction openings 406 (i. e. extraction apertures 406) in both probes the liquids can be guided by the probes into the container or from the container to the outside of the container. Due to the dual function closure simultaneous emptying and venting the container is facilitated. Consequently, the container can be used and drained very fast without the risk of imploding and rigid containers can be drained with this cap. As can be seen from FIG. 4 a sealing means 405, in particular a sealing ring, is comprised by each of the probes 404 and 403. Also other sealing means may be used. The coupling device 408 is programmed and configured to disengage the first closure insert 400 and the first shoulder by axially pushing the first closure insert 400 with the first probe 404. In a similar way, the coupling device is programmed and configured to disengage the second closure insert 401 and the second shoulder by axially pushing the second closure insert 401 with the second probe 403.

To disengage the closure inserts 401 and 402 with the respective wall of the cap 407 the coupling device 408 comprising two probes can be used. The closure inserts may be engaged with the respective circumferential wall, as for example shown in FIG. 2 or 7, such that a first force is needed to push the closure inserts out of their respective engagement. Further, to engage the coupling front section of the respective probe with the corresponding closure insert a second force is needed. This second force can also be applied by pushing the two probes onto the two closure inserts. In a preferred embodiment, the first force is larger than the second force. Thus, when pushing the two probes onto the two closure inserts 400, 401 and when increasing the applied force, first the two closure inserts are engaged with the coupling front sections of the probes and subsequently, when further increasing the force, the closure inserts are pressed out of their engagement with the cap and the two openings of the cap are opened as shown in FIG. 4. The two closure inserts in the cap, i.e. the shoulders of the two openings, and the coupling front sections of the two probes are shaped such that this opening and closure mechanism is provided. Further details hereof are provided in the context of other embodiments, for example in the context of FIG. 7.

FIG. 5 schematically shows a tamper evident cap 500 which can be positioned on top of the first and second openings of a springless cap in accordance with exemplary embodiment of the invention. The tamper evident cap 500 can also be used as dust protection and can be used and placed on top of the cap several times. The tamper evident cap 500 can be fixed on the cap by means of friction between the two circular elements 503 and 504 and between corresponding walls of the openings of the cap. The tamper evident cap 500 comprises a top plane 501 at which a grasping element 502 is provided. In the perspective, sectional view of the tamper evident cap in FIG. 5 the two circular elements 503 and 504 are shown as a semi circles. They are provided for being engaged with the openings of the cap and to close said openings. Moreover, grooves 505 and 506 are positioned at the circular walls 503 and 504 are shown.

FIG. 6 schematically shows a cap 600 with a tamper evident cap 500 for safely securing the openings of the cap 600. In addition locking means 601 and 602 are provided on a top surface of the cap 600. The protrusions 601 and 602 have an L shaped cross action and are positioned on opposing sides of the top surface 600. Tamper evident cap 600 may also be level with elements 601 and 602 and may thus protrude more than shown in FIG. 6. Elements 601 and 602 may also be seen as annular undercuts that releasably engage with the locking interface of the coupling device.

FIG. 7 schematically shows a cross section through a cap 700 as used in accordance with an embodiment of the present invention. A first closure insert 713 and a second closure insert 714 are provided. Moreover, the first probe 709 is partially shown in FIG. 7 as well as second probe 710. In particular, the coupling sections of the first and second probes are depicted here. The cap 700 of FIG. 7 comprises an internal thread 707. Moreover, the locking means 708 facilitate an engagement with a locking collar. The first closure insert 713 comprises several radially deformable sidewalls 701 and 702. Moreover, the second closure insert 714 comprises several radially deformable sidewalls 703 and 704. The radially deformable sidewalls are each adapted to releasably engage with the respective shoulder 705 and 706 of the respective openings of the cap. As can be gathered from surface 711 of the first probe 709 and the surface 712 of the first closure insert 713 a form closure, at least partially, between the coupling section of the first probe and the first closure insert is provided. The same holds true in a similar way for the combination of the second probe and the second closure insert. Consequently, by axially pushing the closure inserts towards the bottom of the container, i.e. from the top to the bottom of FIG. 7, the radially deformable sidewalls 701, 702, 703 and 704, are deflected inwardly and they move into a respective recess of the probe. Said recesses are embodied in the example of FIG. 7 as a circumferentially extending deepening. However, also other embodiments are possible. For example, the probes may comprise an elastically deformable section which can be compressed by the radially deformable sidewalls during their deflection. Due to the radial deflection along the inward direction the closure inserts are disengaged with the shoulders of 705 and 706 and due to the applied pressure the closure inserts are coupled with the probes, i.e. engaged with the probes. Thus, by further pushing the respective closure inserts with the respective probes the cap can be opened at the first and second openings. Furthermore, upon axially pulling the closure inserts 713, 714 from the disengaged configuration and in a direction away from the bottom of the container body (i.e. from the bottom to the top of FIG. 7), the closure inserts can be reengaged with the corresponding shoulder 705, 706 such that the corresponding opening of the cap 700 is again fluid tightly closed. Moreover, FIG. 7 shows recessions or grooves 715, 716 and 717 which are positioned in the cap for enhancing the deflectability of the engaging parts of the cap. The circumferential walls as described herein engage with the corresponding closure inserts 713, 714 such that said walls having the shoulders 705, 706 have an increased flexibility. Upon pressing the closure inserts out of the engagement with these walls, the walls can thus deflect outwardly.

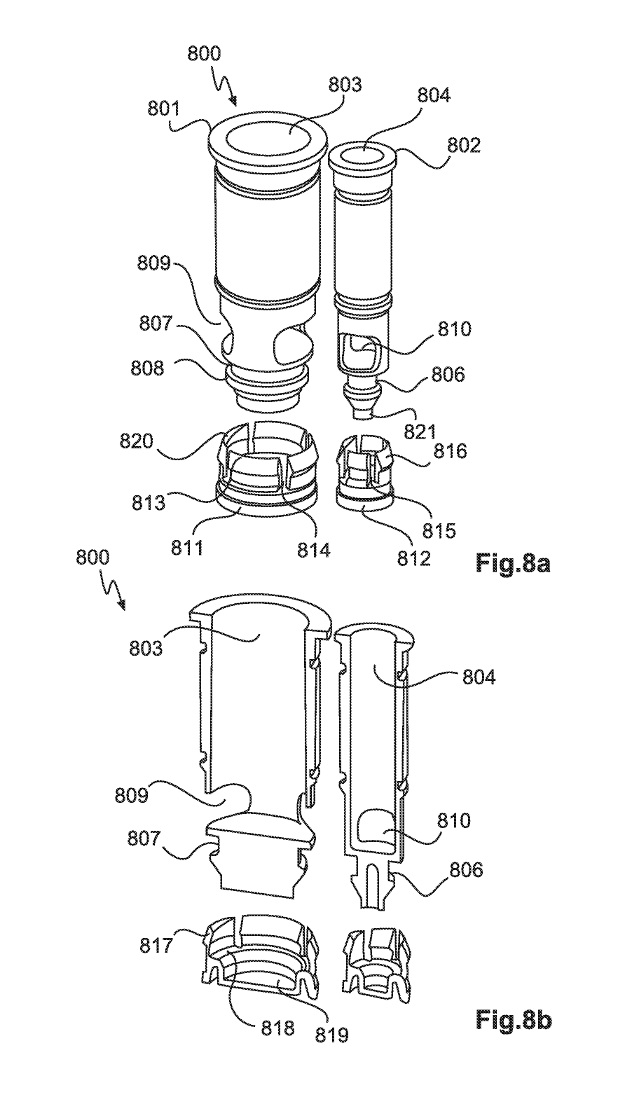

FIGS. 8a and 8b are two illustrations of probes and closure inserts used in accordance with an exemplary embodiment of the present invention. Therein, FIG. 8a is a complete depiction of a first and a second probe and first and second closure inserts whereas FIG. 8b is a cross sectional view of said elements. First probe 801 comprises a first internal channel 803 which is connected to the first extraction aperture 809. A circumferential recess 807 provides enough space the inwardly moving sidewalls 813 of the closure insert 810. A circumferential edge 808 extends around the complete circumference of the first probe 801. Moreover, the coupling front section 820 is shown which is adapted to be couple with the first closure insert 811. If desired form closures between the section 820 and the deformable sidewall of the closure insert can be used. Several radially deformable sidewalls 813 are depicted and also a recess 814 is shown in FIG. 8a. In a similar way, the second probe 802 comprises a second extraction aperture 810 and has a second inner channel 804 which is connected to the second extraction aperture 810.

The coupling front section 821 of the second probe is adapted to couple with the second closure insert such that upon pushing the second probe onto the second closure insert the coupling front section couples with the second closure insert. Such a coupling is also achieved during the engagement of the second closure insert with the second shoulder as depicted with 201 in FIG. 2. Upon further pushing of the second probe onto the second closure insert the second closure insert is forced off its engagement with the second shoulder such that the second extraction aperture 810 is accessible from an inner volume of the container body. The same principle applies for the previously described first probe 801 and first closure insert 811. As can be seen from the cross sectional view of FIG. 8b the closure inserts comprise a bottom 819 as well as an angled section 818 that builds the form closure with an angled counter part of the front section 820. Aspects of the form closure have been described previously and will be disclosed in more detail in the following. Moreover, the protrusion 817 of the radially deformable sidewall facilitates the mechanical engagement for engaging and re-engaging the closure inserts with the respective shoulder.

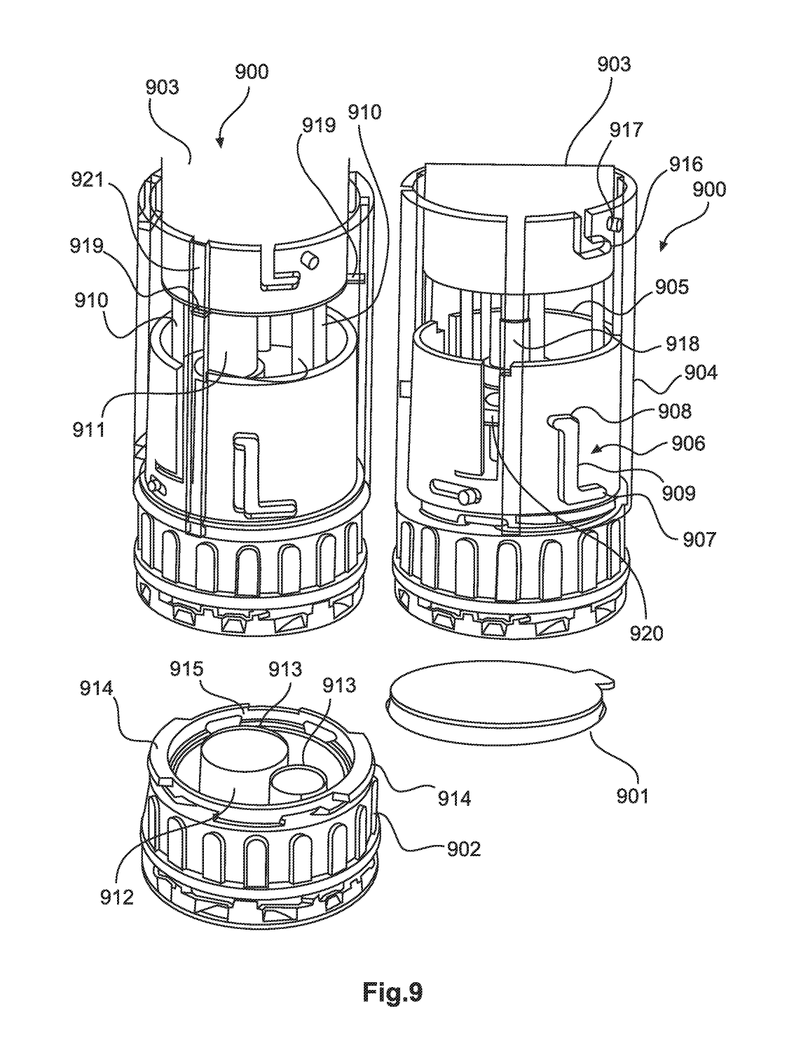

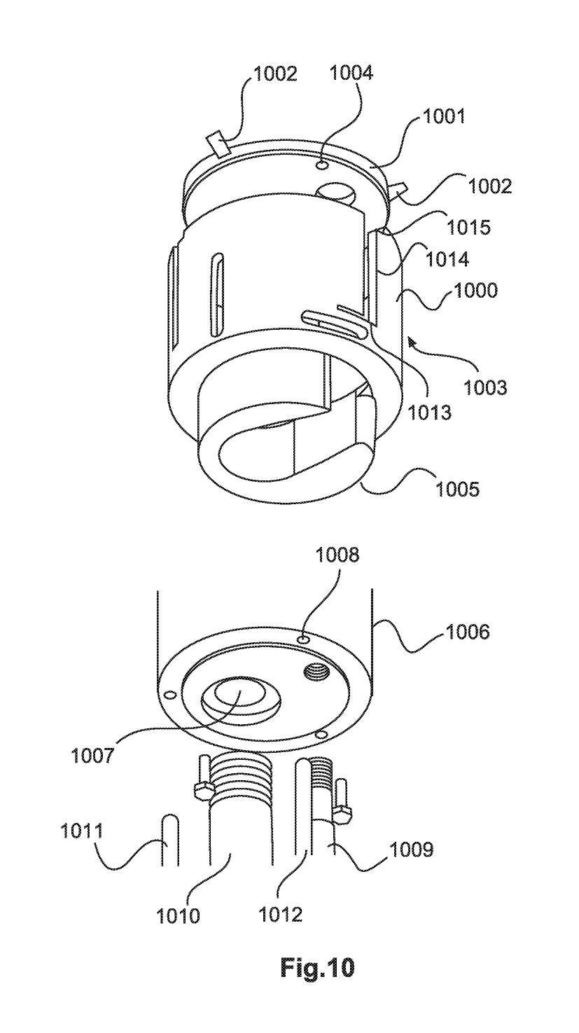

FIG. 9 schematically shows a coupling device 900, wherein two different perspectives of the device are shown at the top of FIG. 9. Although some parts of the device 900 completely surround other parts of the device, said other parts are depicted as well in FIG. 9. Thus, FIG. 9 may be seen as translucent depiction of the parts of device 900. A dust cap 901 and a cap 902 are depicted in FIG. 9 as well. A first tubular component 904 which is part of a coupler jacket is shown and the tubular component 904 surrounds the coupler body 903. In principle, the coupler body 903 is movably attached to the first tubular component 904 and is also movably attached to the second tubular component 905. The first tubular component 904 also surrounds the second tubular component 905. The first tubular component 904 comprises a first guiding track 906 which has a first transversal section 907, a second transversal section 908 and a longitudinal section 909. Alternatively, also a helical section could be provided between the first and second transversal section. A first protrusion or a first pin that is engaging the first guiding track is not shown in FIG. 9. However, this first protrusion can be gathered from following FIG. 10 where it is shown with reference sign 1002. The first probe 911 and the second probe 918 are screwed to the coupler body 903 and a sleeve plate 920 at which the first and second sleeves are positioned is movably attached via guiding racks 910 to the coupler body 903. The sleeve plate 920 may make a translational movement in distal or proximal direction such that the sleeves glide over the corresponding probe of the coupler body 903. Second protrusions 919 are part of a plate which is fixed to the distal front section of coupler body 903. Such a plate can be gathered from FIG. 11 where it is shown with reference sign 1107. It should be noted that FIG. 11 depicts a dissembled configuration of the coupling device. Corresponding recessions 921 are provided on the inner side of the first tubular component 904 such that the second protrusions 919 of the plate can glide in a longitudinal direction in proximal as well as in distal direction.

The coupling device 900 of FIG. 9 allows an interlocked actuation of the probes and the sleeves and this ensures the correct sequence of probe and sleeve positions so that the operator exposure is minimized. It should be noted that independent from the driving force for the sleeve motion it is essential to confirm that the probe extraction apertures are closed and prevented from generating leaks at all stages of the operation. The coupling device 900 allows a sequence of manual actions which ensure that the sleeves are correctly positioned at all parts of the operation. This ensures that the probes cannot open prematurely or remain open when the coupling device is being disengaged from the cap 902. The probe movement and the sleeve movement is controlled by the external operation and movement of the components of the coupling device 900. An action to disconnect the coupling device ensures the complete closure of the probes before the disconnection is completed. As will be explained in more detail hereinafter, the exact position of the sleeves is guaranteed with external mechanical actuation. Unintended leakage can thus be avoided by the coupling device 900. The coupling device 900 can be securely locked with the cap 902 by engaging locking means 914 with a locking interface of the coupling device 900. Cap 902 also comprises an alignment ring 915 which extends around the two openings 913 in which the closure inserts are provided. A gap 912 provides enough room for a protrusion of the coupling device 900. Such a protrusion and gap can be shaped such that a key lock feature is provided. Details about such a key lock feature will be provided in more detail hereinafter. Device 900 also comprises a hole 917 for assembly purposes and an L shaped guiding track 916 which can be used for an engagement with a protrusion of the coupler body to additionally lock the proximal end position.

The process of mechanically coupling the coupling device 900 to the cap 902 may be described as follows. A fixation of the coupling device 900 at the cap 902 is carried out by engaging the respective locking means. The sleeves of the coupler body 903 are inserted into the cap. By pressing down the coupling device 903 towards the container, the sleeves are moved towards the cap and pressed with the O-rings into the openings of the cap to form a liquid tight connection. At the same time the probes, which may have different lengths, are pushed towards the plugs of the cap. In the exemplary embodiment of FIG. 9, a thin long probe and a short thick probe are provided. The longer probe (thin probe) is just engaged with the plug, i.e. with the closure insert of the cap, but does not yet push it in. The shorter probe (thick probe) is not yet engaged with the plug. Therefore, the container is still closed. In this situation the first protrusions connected to the sleeve plate are reaching a 90° turns of the first guiding track 906. After the first protrusions (see also FIG. 10, protrusions 1002) have reached the 90° corner, the first tubular component 904 has to be turned clockwise to open a further vertical track to move the probes together with the coupler body. Rotating the coupler body 903 for example for around 20° allows a further longitudinal movement of the probes in distal direction. The engaging and disengaging process between the probes and the respective closure inserts has been described before in detail to which sections is referred. After the extraction opening in the probes reaches the lower level of the cap within the container, the second protrusions 919 of the coupler body reach an abutment which prevents a further emersion of the probes into the container. The container is now open. To release the jacket from the status in “open”, a little resistance has to be overcome which secures the coupling device in the end position. For example, a small sphere has to be pushed back against the spring. However, also other mechanisms may be used to provide such a resistance. The coupler jacket has to be turned again counter-clockwise and the protrusions 919 of the coupler body reach the 90° corner between the first transversal section 1013 and the vertical section 1014 (see FIG. 10). In this vertical section, the probes can be pulled back from the container. Removing the probes from the container by pulling the container body 903 in proximal direction closes at first the large plug and disengages the large plug from the thick probe and then closes the small plug. The thin probe and small plug are not disengaged, the bottle is now reclosed. Subsequently, the coupling device may be prepared for disengaging the sleeves. The first tubular component 904 has to be turned counter-clockwise to reach the vertical track to move the probes and the sleeves. When the first protrusion which engages with the first guiding track 906 abuts at the proximal end of the guiding track against the proximal wall of the second transversal section 908, a further rotation can be carried out in order to lock the position of the coupler body 903. To move the tubular component 904 into the end position, a little resistance has to be overcome which secures the coupler into the position closed. For example, a small sphere has to be pushed back against a spring. The protrusion 1005 (see FIG. 10) and 1112 (see FIG. 11) can now be taken out of the gap 912 of the cap 902 and the coupling device and the cap can be separated.

FIG. 10 is an enlarged view of components of the coupling device 900 of FIG. 9. In detail, the second tubular component 905 of FIG. 9 is depicted in FIG. 10 with reference sign 1000. The second tubular component comprises the second guiding track 1003 which has a first transversal section 1013, a second transversal section 1014 and a longitudinal or helical section 1015. Furthermore, the protrusion 1005 at the distal end of component 1000 is shown. Furthermore, FIG. 10 depicts a sleeve plate 1001 which comprises a plurality of first protrusions 1002. Moreover, fixation holes 1004 for guiding rods or guiding tubes are provided. FIG. 10 further depicts the coupler body 1006 which comprises openings 1008 for receiving the guiding rods or guiding tubes. Moreover, openings 1007 for receiving the probes 1010 and 1009 are shown. The guiding tubes are depicted with 1011 and 1012.

FIG. 11 shows the coupling device of FIG. 9 in a dissembled configuration 1100. A plate 1107 with a plurality of second protrusions 1108 is shown. This plate will be mounted at the lower end of coupler body 1103. A gripping component 1114 is provided which can be seen as part of the coupler jacket. In this embodiment, the coupler jacket comprises the gripping component 1114, the first tubular component 1110 and the second tubular component 1109. The second tubular component comprises the protrusion 1112 which can be used as a locking interface as described herein. A cap 1111 is also shown. A hole or aperture 1103 in the coupler body 1101 is shown for providing or extracting material to or from the container. The coupler body also comprises an air inlet valve 1102 and the two probes 1105 are depicted in a dissembled configuration. Moreover, the sleeve plate 1106 can be seen in FIG. 11. Connecting components 1104 are also shown in FIG. 11. The first tubular component 1110 comprises a Z shaped first guiding track 1113 and an additional guiding track 1115 for locking the end position. Connectors 1104 to be attached to the coupler body are also shown.

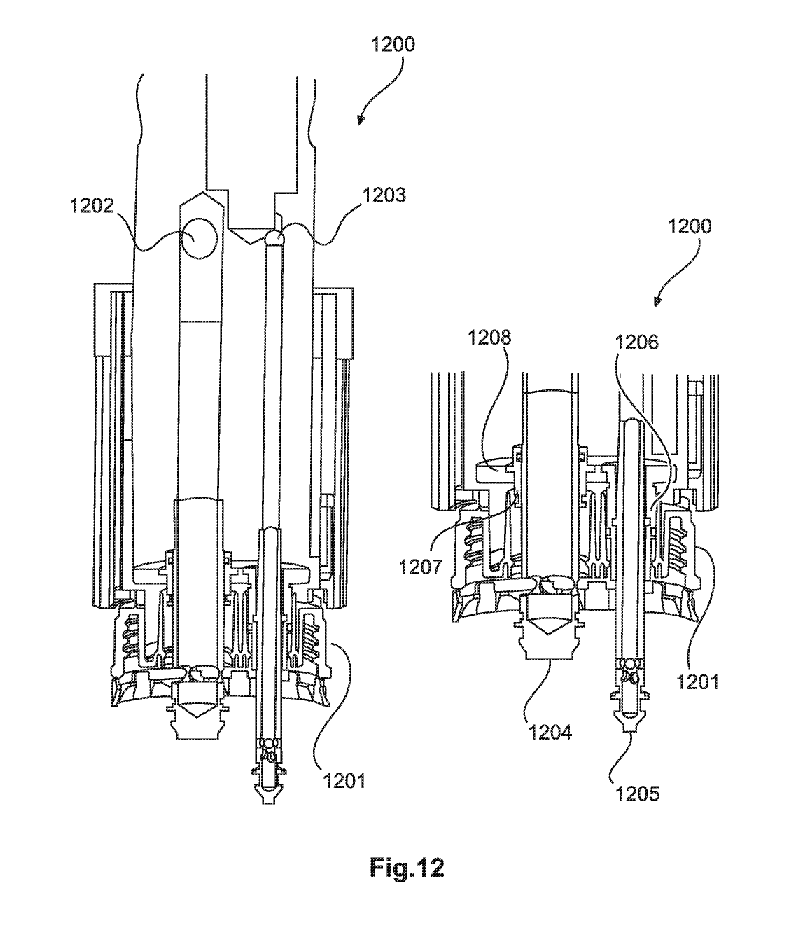

FIG. 12 shows another exemplary embodiment of a coupling device 1200. A suction exit hole 1202 and a rinsing water entrance hole 1203 is shown in the coupler body. The coupling device 1200 is shown in a coupled configuration together with cap 1201. The cross-sectional views of FIG. 12 show a situation where a first long and small probe is already provided in the container whereas the second probe at least with its extraction aperture is not yet protruding into the container. On the right-hand side a sleeve plate 1208 is shown at which the first sleeve 1206 and the second sleeve 1207 are fixed. The first and second sleeves together with the sleeve plate are movably attached such that they can glide over the first probe 1205 and the second processor 1204.

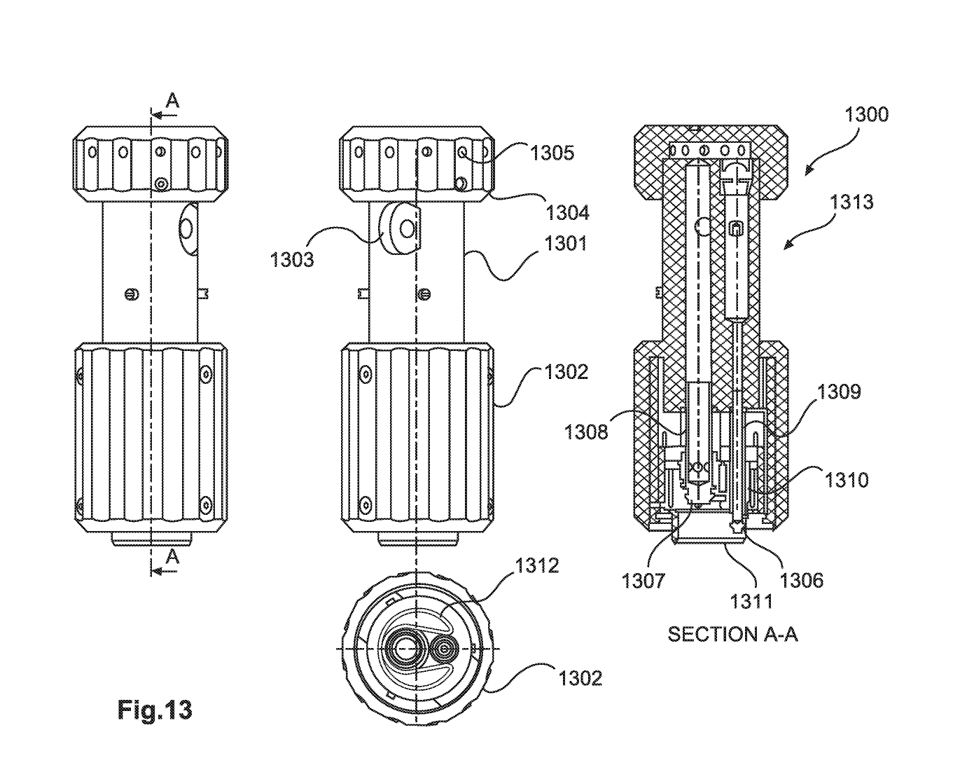

According to another exemplary embodiment of the present invention, a coupling device 1300 is shown in FIG. 13. Three different views of the coupling device are presented in FIG. 13. Furthermore, a top view of a cap together with a coupling device is provided at the bottom of FIG. 13. A suction exit hole 1303 is depicted in the middle view of FIG. 13. The coupler body 1301 comprises a gripping unit 1304 which comprises at least one air inlet hole 1305. The coupler jacket 1302 is movably attached to the coupler body 1301. On the right-hand side of FIG. 13, a cross-sectional view along section A-A is shown. The first and second probes 1306 and 1307 are surrounded by the coupler jacket 1302 in the shown proximal end position 1313. The sleeves 1308 and 1309 are slidably attached to the probes such that they can be moved for example such that they can be moved over the probes to cover extraction apertures of the probes or to release extraction apertures of the probes. The protrusion 1311 which can engage with the cap is shown in FIG. 13 as well. The top view shown at the bottom of FIG. 13 shows a protrusion key lock 1312 together with the jacket 1302 of the coupling device 1300.

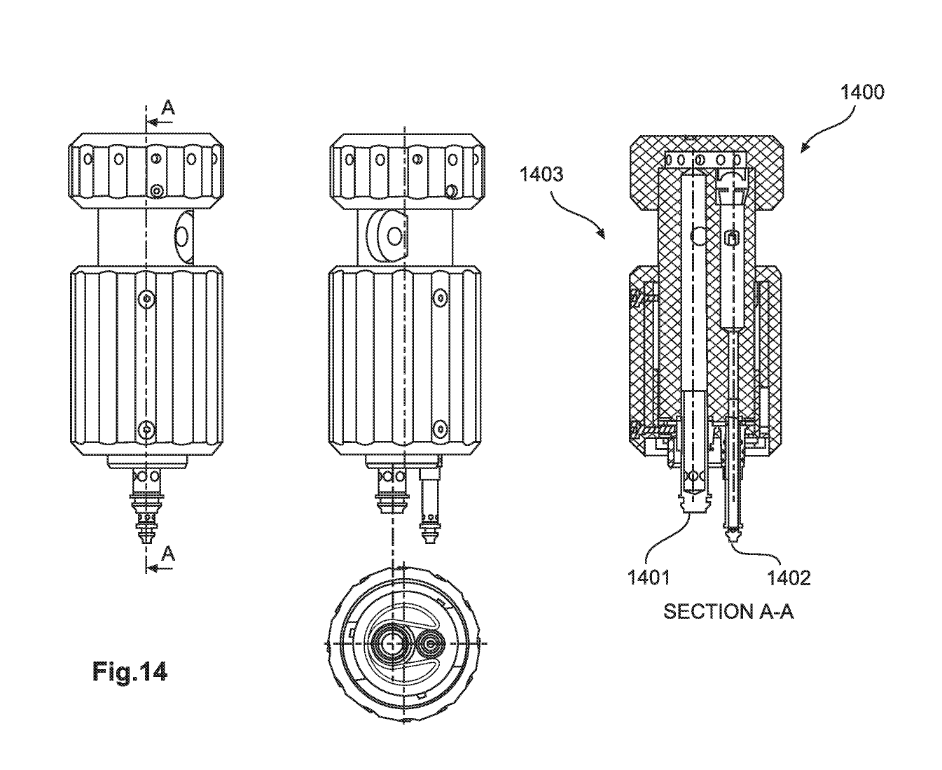

FIG. 14 shows the coupling device 1400 which is identical to the device shown in FIG. 13 but the first and second probes 1401 and 1402 are depicted in the distal end position.

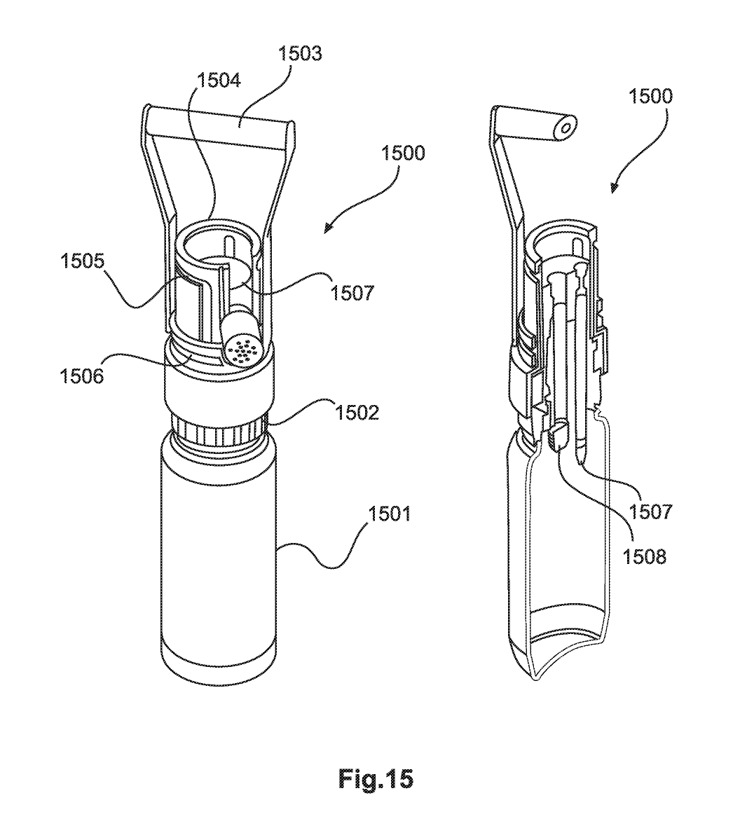

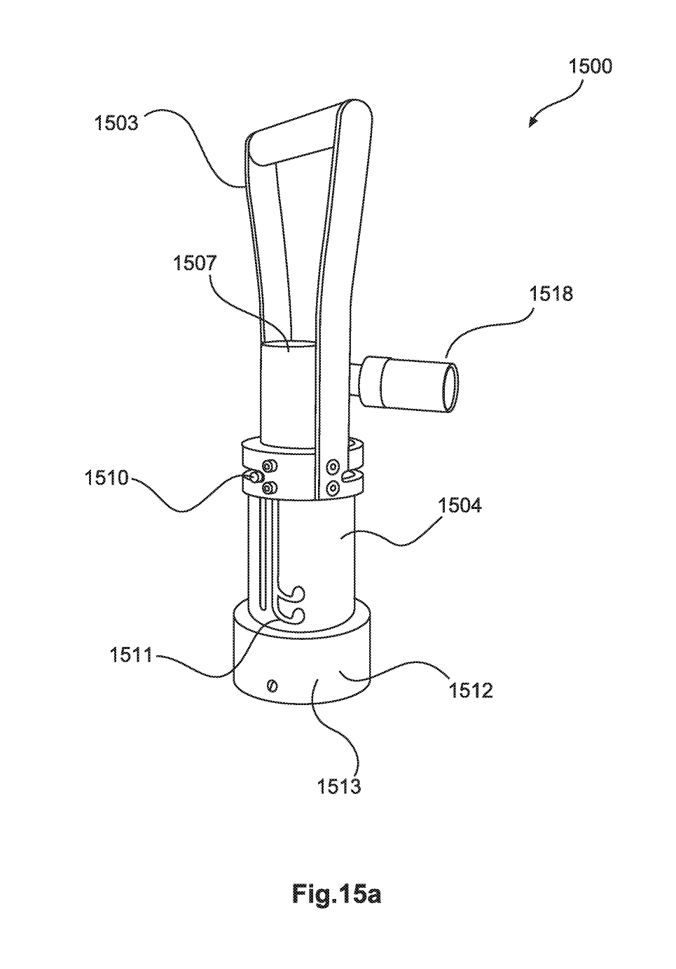

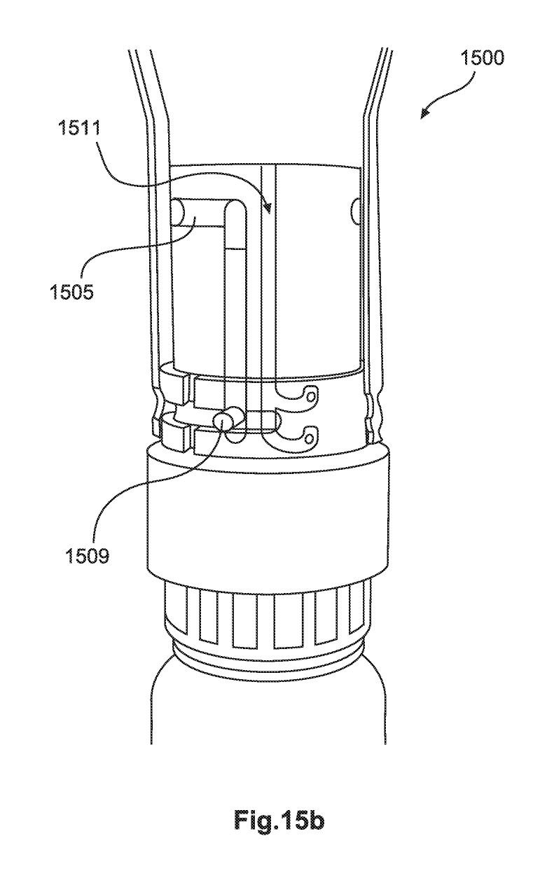

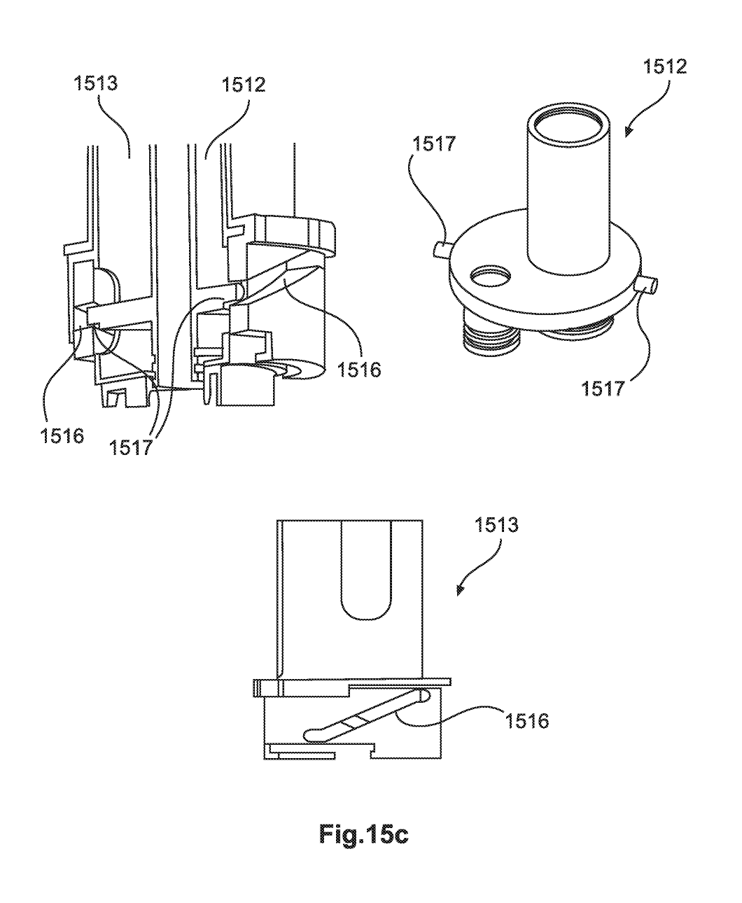

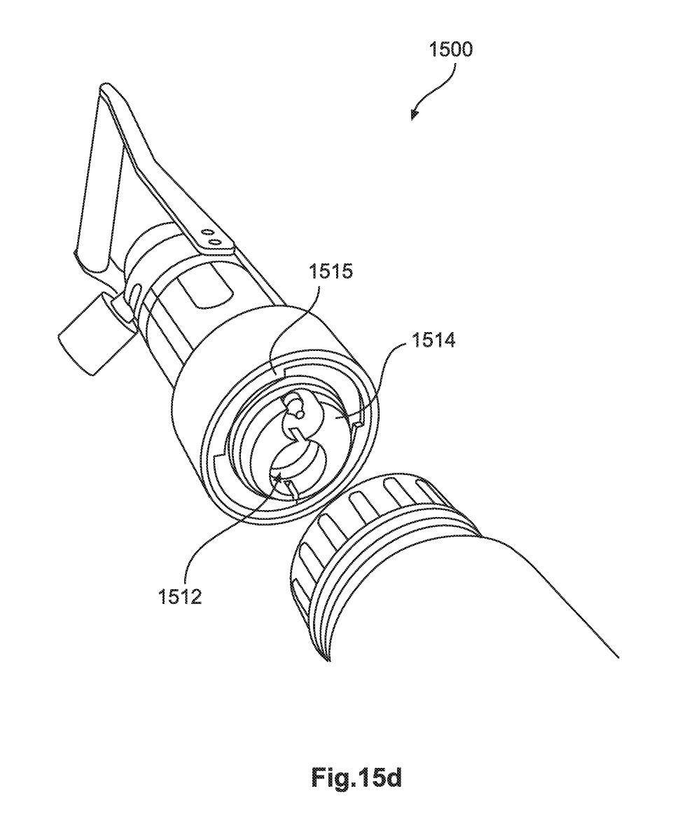

According to another exemplary embodiment of the present invention, FIG. 15 and FIGS. 15a to 15d show a coupling device 1500 with a coupler body 1507 and a multi-component coupler jacket 1504. In the following this embodiment of the coupling device 1500 will be described with respect to FIG. 15 and FIGS. 15a to 15d although some parts are only depicted in one of said Figures. A handle 1503 is comprised at which a horizontal guiding track 1506 is provided in which a protrusion of the coupler body engages in FIG. 15. Furthermore, at the component 1504 of the coupler jacket, a further guiding track 1505 with a vertical and horizontal section is provided. The cap 1502 is in engagement with the container 1501. The first and second probes 1507 and 1508 are shown on the right-hand side of FIG. 15 where a cross-sectional view of the coupling device 1500 including the container is shown. The process of engaging the coupling device 1500 with the cap 1502 is similar or the same as described before. A key component 1514 and a locking feature 1515 (see FIG. 15d) are provided at the coupling device. The key component at the base of the coupling device ensures correct fitment into the cap up stands. By turning handle 1503 clockwise for 60° the coupling device 1500 is locked onto the cap 1502. At the same time two movements are performed by the user. First, the horizontal guiding track 1505 of the multi-component coupler jacket 1504 is moving over the protrusion/pin 1509 (for the protrusion/pin see FIG. 15b) which is connected to the coupler body 1507. Second, the helix 1516 (see FIG. 15c) into which pins 1517 of sleeve holder 1512 engage moves sleeve holder 1512 into the cap 1502 engaging with the cap openings 106, 107, which can be gathered from for example FIG. 1 and which then creating a seal. Vertical movement of the coupler body 1507 engages the probes and inserts the probes vertically into the bottle. Locking pins 1510 run down a track to ensure second stage locking. The probes are locked by the locking pins 1510 into the final position of the handle locking track 1511 by turning the handle 1503 counter clockwise 15° to ensure the probes do not release unintentionally. Internal compressed springs ensure that the coupling device remains in the locked position and prevents unintentional release during use. The device also comprises an air valve 1518, for example a 25 mm air valve. Of course other embodiments implementing different degrees of clockwise or counter clockwise rotations can be used.

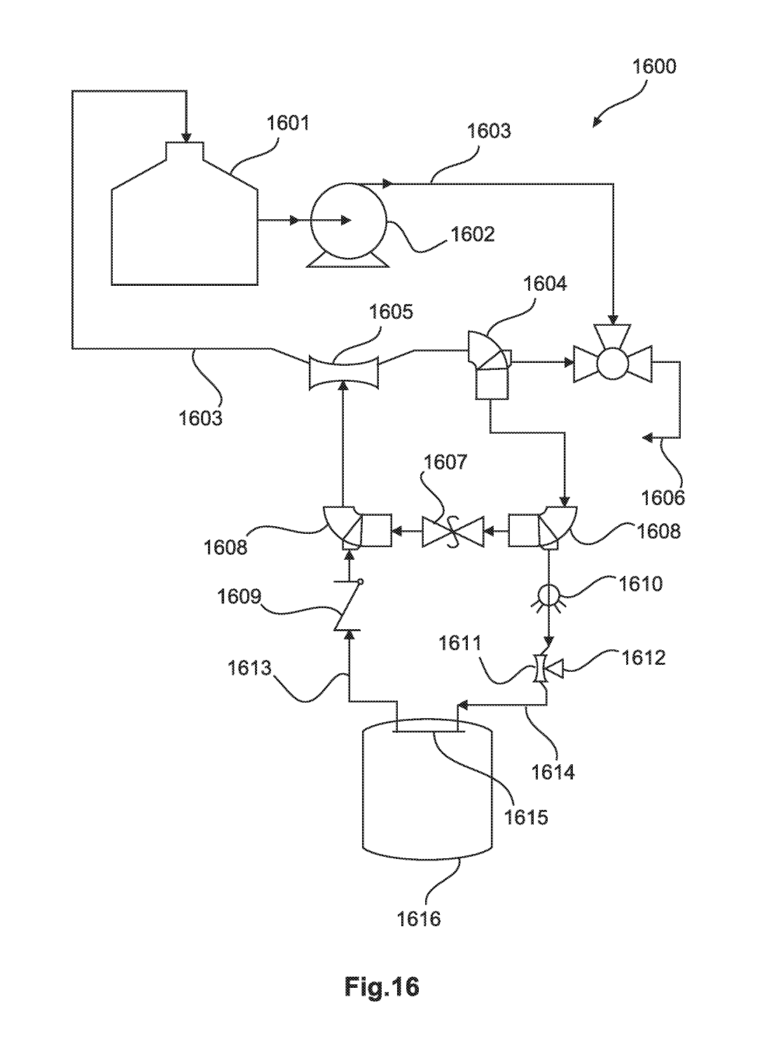

In the following an aspect of the present invention relating to a venturi valve will be explained, particularly but not only in the context of FIG. 16. According to another exemplary embodiment of the present invention, a coupling device, for example the coupling device of the present invention or another coupling device, is provided together with a new vacuum control device. This new vacuum control device can be used without any other element mentioned herein and can also be used with other coupling devices as the ones mentioned herein. This will explained later on in the context of FIG. 16.

The inventors of the present invention found that when the air inlet valve provided in the coupler, i.e., the coupling device, the coupler experiences back-pressure when the coupler is connected directly to the water circuit of the coupler. This holds the valve closed and because the volume of water entering the container is less than the volume of air extracted by the system vacuum the pressure in the container falls below ambient and the container collapses. The following disadvantages may result therefrom. First, pressurization of the valve during the rinsing process may occur and second, deformation of the container due to the reduced volume flow during the rinsing process may occur. Thus, the basic technical problem that is solved by this venturi valve or the new vacuum control device is that some product containers, with low inherent structural strength, respond to an imbalanced volume extraction to inlet volume by deforming as the external ambient pressure is higher than the internal pressure generated by the system vacuum.

In other words the inventors found that when a chemical container is connected to a sprayer in the process of emptying the contents it is convenient to provide the operator with a means to control the speed of emptying and the amount of effort applied by the sprayer so that the chemical product flows at rate that is acceptable and irrespective of the size or strength of the container and allows the operator to make accurate measurement of the volume transferred through a suitable measuring device which could be volumetric, flow meter, mass based or any other appropriate device. The use of the venturi as explained here matches these needs.

The technical features of which solve this problem is the inclusion of a venturi to the rinsing conduit of the coupler which generates a local low pressure zone at the back of the air inlet valve and this causes the valve to open and the air flow joins with the liquid flow. This effect prevents a build up of liquid at the back of the valve. This reduces the recovery time to re-establish internal container pressure equilibrium after rinsing. The air entrained in the rinsing water assists in maintaining an equality of volume into the container while exposed to the system vacuum and the rinsing system is operated.

The advantages of this use of the venturi and the new vacuum control device are that this is a very low cost and effective addition to the coupler functionality which removes the need for complex additional valves, forced air inlets and other supplemental means of maintaining an equilibrium of volume exchange. First, a creation of suction at the back-pressure valve is provided. Also a protection of the valve against excessive pressure is provided. Also additional operational safety is provided, i.e., no rinsing liquid can escape the valve during the rinsing process. Furthermore, additional aspiration of air during rinsing is achieved as a reduced container contraction is realized. Also a higher rinsing efficiency due to air/water turbulence is an advantage. Moreover, the prevention of fluid build up and pressure behind the air inlet valve and conduit that has to be aspirated before the air flow is re-established. This delivers a quicker recovery time between rinsing and emptying actions.

In this context FIG. 16 shows a system 1600 with such an advantageous use of the venturi and new vacuum control device with a coupling device. The system of FIG. 16 comprises a sprayer tank 1601 and a pump 1602. Connection lines 1603 are used to distribute the desired media within the system 1600. A tee 1604 is provided and a venturi 1605 is shown. The tee 1608 is shown and a quarter turn ball valve 1607 is used to regulate the vacuum. The coupling device 1615 is coupled to the product container 1616. The rinse line is shown with 1614 and a micro venturi 1611 is provided. Furthermore, an air inlet 1612 is provided. A Non Return Valve (NRV) 1609 is also shown. This is included in the system to allow product to flow from the container to the sprayer but it prevents any liquid circulating in the system entering the container. The objective is to prevent the co-mingling of concentrated product in the container and the circulation liquid while at the same time ensuring that the container cannot be subject to an overpressure. Element 1610 is a ‘hold to run’ trigger valve that when operated releases pressurized circulation liquid into the coupler and then the container to allow the container to be rinsed. As soon as the trigger is released the valve closes and the flow stops.

The technical solution illustrated in FIG. 16 provides the operator with a quarter turn valve, or similar flow control that connects a pipe containing pressurised liquid from the sprayer that might be used for rinsing the container at some point, to the pipe arranged for conveying the product to be transferred from the attached container. When the valve is fully closed the system pressure of the sprayer is at maximum and the suction applied to the product container is also at the maximum and the flow path to the sprayer of the liquid to be transferred is not obstructed by any other flow or device. If the quarter turn valve is progressively opened the pressurised liquid is allowed to escape into the pipe conveying the liquid to be transferred into the sprayer. This action provides the following controls: First, the diverted sprayer liquid occupies some of the available flow path previously provided for the product to be transferred and the rate of transfer is therefore reduced. Second, the diverted pressurised sprayer liquid reduces the overall system pressure and this also reduces the pressure available at a venturi or similar device used to affect the product transfer and the reduced pressure results in a lower velocity and a consequential reduction in transfer speed available. To prevent the pressurised sprayer liquid entering the container and diluting the product or adding to the volume this system conveniently includes a non-return valve to allow fluid flow at the control device to travel in one direction only to the sprayer and not to the connected product container. If the valve is fully opened the flow path for the liquid to be transferred is almost fully satisfied with the pressurised sprayer liquid and as a consequence the sprayer system pressure is reduced to a minimum level and the effort to transfer is greatly reduced. In this condition the flow from the container ceases and the device can therefore be used to control the flow for the purpose of measuring. Conveniently this device also means that the rate of transfer can be controlled with ease without using a positive closing valve in the transfer pipe between the container and sprayer. If such a positive closure valve was used it would potentially allow the operator to close the valve and to introduce rinsing liquid at a variable and potentially high pressure into the product container without providing a suitable exit for the incoming liquid. The resulting pressure would therefore build in the product container and could cause the container to burst. The vacuum control device described above makes this unhelpful condition impossible to achieve and the system provides an intrinsically safe solution to product flow control as the pipe from container to sprayer is always open and able to vent directly back to the sprayers main tank.

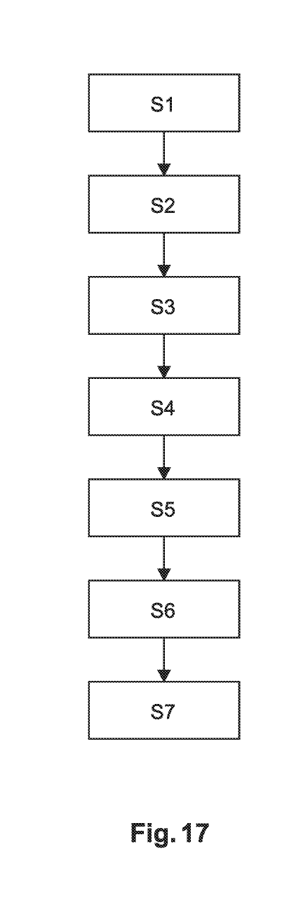

FIG. 17 shows a method of mechanically coupling a coupling device to a cap of a container according to an exemplary embodiment of the present invention. In principle, the shown method steps S1 to S3 can be seen as a separate embodiment which can be carried out without the steps S4 to S7. However, in the following, this method will be described by means of completing the steps S1 to S7.

The method of FIG. 17 comprises the step S1, i.e., providing for the container having a container body (S1), wherein the container body comprises at least one inlet opening and a springless cap attached to the inlet opening closing the inlet opening. The cap is as described hereinbefore. The method further comprises the steps of coupling the container via the springless cap with a coupling device thereby inserting a first probe of the coupling device into the first opening of the cap and inserting a second probe of the coupling device into the second opening of the cap, which is shown with step S2. In step S3 the first closure insert and the first shoulder are disengaged by axially pushing the first closure insert by the first probe and/or the second closure insert and the second shoulder are disengaged by axially pushing the second closure insert by the second probe (S3). This may be carried out by applying any of the coupling devices as described herein.

Further, in step S4 the first sleeve and the second sleeve of the coupling device are blocked at a first predetermined longitudinal position by the coupling device thereby preventing a translational movement of the first and second sleeves in proximal direction. Therein the first and second probes are in a second predetermined longitudinal position when the first and second sleeves are in the first predetermined longitudinal position. In step S5 a further translational movement of the first and second probes from said second predetermined longitudinal position in distal direction is allowed only when the first and second sleeves are blocked at the first predetermined longitudinal position. Moreover, in step S6 the first and the second probes are blocked by the coupling device in distal direction at the second predetermined longitudinal position thereby preventing a translational movement of the first and second probes in distal direction. A translational movement of the first and second sleeves from the first predetermined longitudinal position and in proximal direction are allowed in step S7 only when the first and second probes are blocked in distal direction at the second predetermined longitudinal position.

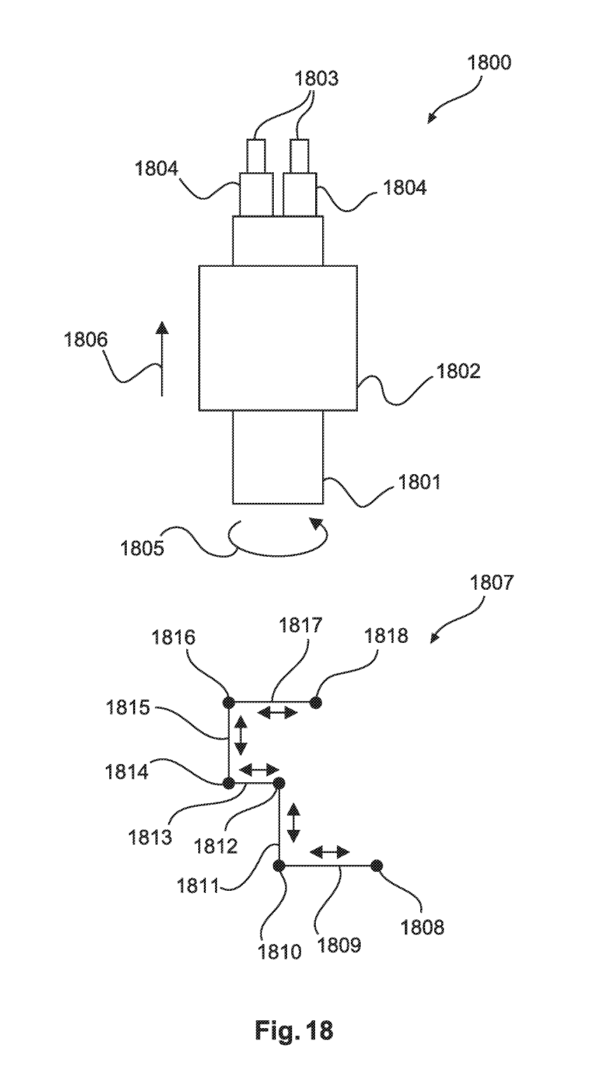

FIG. 18 shows a coupling device 1800 according to an exemplary embodiment of the present invention. The coupling device comprises a coupler body 1801 and a coupler jacket 1802 which can be moved relative to each other by a rotation 1805 in clockwise and counter-clockwise direction. Furthermore, also a translational movement 1806 of the coupler body relative to the jacket can be carried out in proximal and distal direction. The first and second probes 1803 are provided with respective sleeves 1804. At the bottom of FIG. 18, a diagram 1807 illustrates the movement of the coupler jacket 1802 relative to the coupler body 1801 by means of which different functionalities of the coupling device 1800 can be achieved as has been described herein in the context of other embodiments. In the following, the movements will be described with respect to the coupler jacket 1802 relative to the coupler body 1801. Starting at a first rotational position 1808, a rotation 1809 can be caused until a second rotational position 1810 is reached. In this second rotational position, a translation 18011 is allowed by the coupling device 1800. This translational movement is caused until an abutment at the position 1812 is reached. This position 1812 may be seen as a third rotational position in case the previous movement comprises a rotational component. With a further rotation 1813, a fourth rotational position 1814 is achieved. Subsequently, a translational movement 1815 can be carried out until position 1816 is achieved. Only then a further rotational movement, in this case in the contrary direction to the previous rotations, is carried out and shown with 1817 until an end position 1818 is reached.

The mechanical principle of the embodiment shown in FIG. 18 can be applied to various coupling devices, particularly to coupling devices as shown e.g. in FIGS. 9 to 15.

1-25. (canceled)

26. A coupling device configured to be mechanically coupled to a springless cap of a container to be in a coupled configuration, the coupling device comprising
a first probe configured to be inserted into a first opening of the cap,
a second probe configured to be inserted into a second opening of the cap,
a first sleeve configured to cover a first extraction aperture of the first probe,
a second sleeve configured to cover a second extraction aperture of the second probe,
wherein the first sleeve is slideably attached to the first probe,
wherein the second sleeve is slideably attached to the second probe,
wherein the coupling device is configured, when in the coupled configuration, to disengage a first closure insert of the cap from a first shoulder of the cap by axially pushing the first closure insert with the first probe, and
wherein the coupling device is configured, when in the coupled configuration, to disengage a second closure insert of the cap from a second shoulder of the cap by axially pushing the second closure insert with the second probe.

27. The coupling device according to claim 26,
wherein the coupling device is configured to block the first and the second sleeves at a first predetermined longitudinal position thereby preventing a translational movement of the first and second sleeves in proximal direction,
wherein the first and second probes are in a second predetermined longitudinal position when the first and second sleeves are in the first predetermined longitudinal position, and
wherein the coupling device is configured to allow a further translational movement of the first and second probes from said second predetermined longitudinal position in distal direction only when the first and second sleeves are blocked at the first predetermined longitudinal position.

28. The coupling device according to claim 27, further comprising a coupler body,
a coupler jacket, and
wherein the coupling device is configured to block the first and the second sleeves in proximal direction at the first predetermined longitudinal position when the coupler body and the coupler jacket are rotated relative to each other.

29. The coupling device according to claim 28,
wherein the coupler jacket comprises a first guiding track,
wherein the first guiding track has a first transversal section, a second transversal section and a longitudinal section or helical section, and
wherein the coupler body comprises a first protrusion that engages with the first guiding track of the coupler jacket, and
wherein the blocking of the first and second sleeves at the first predetermined longitudinal position in proximal direction is defined by an engagement of the first protrusion with the first transversal section of the first guiding track.

30. The coupling device according to claim 28
wherein the coupler body and the coupler jacket are configured to move relative to each other by a translational movement and/or by a rotational movement,
wherein the coupler body is movable relative to the coupler jacket from a proximal end position to a distal end position,
wherein the coupling device is configured to block the translational movement of the coupler body from the proximal end position in distal direction when the coupler jacket is in a first rotational position relative to the coupler body, and
wherein the coupling device is configured to allow the translational movement of the coupler body from the proximal end position in distal direction when the coupler jacket is in a second rotational position relative to the coupler body.

31. The coupling device according to claim 30,
wherein the blocking of the translational movement of the coupler body from the proximal end position in distal direction is defined by an engagement of a first protrusion of the coupler body with a first guiding track of the coupler jacket,
wherein the first protrusion is positioned in a second transversal section of the first guiding track when the coupler jacket is in the first rotational position relative to the coupler body, and
wherein the first protrusion is positioned in a longitudinal or helical section of the first guiding track when the coupler jacket is in the second rotational position relative to the coupler body.

32. The coupling device according to claim 29,
wherein the coupling device is configured to allow for a synchronous translation in distal direction of the coupler body, the first and second probes and the first and second sleeves until the first protrusion abuts against the first transversal section of the first guiding track,
wherein the coupler body and the coupler jacket are rotatable relative to each other from a third rotational position to a fourth rotational position of the coupler jacket relative to the coupler body when the first protrusion abuts against the first transversal section,
wherein the first protrusion is positioned in the first transversal section of the guiding track when the coupler jacket is in the fourth rotational position relative to the coupler body, and
wherein the coupling device is configured to allow a further translational movement in distal direction of the coupler body and the first and second probes when the coupler jacket is in the fourth rotational position relative to the coupler body.

33. The coupling device according to claim 27,
wherein the coupling device is configured to block the first and the second probes in distal direction at the second predetermined longitudinal position thereby preventing a further translational movement of the first and second probes in distal direction, and
wherein the coupling device is configured to allow a translational movement of the first and second sleeves from the first predetermined longitudinal position and in proximal direction only when the first and second probes are blocked in distal direction at the second predetermined longitudinal position.

34. The coupling device according to claim 33, further comprising
a coupler body,
a coupler jacket, and
wherein the coupling device is configured to block the first and the second probes in distal direction at the second predetermined longitudinal position when the coupler body and the coupler jacket are rotated relative to each other.

35. The coupling device according to claim 34,
wherein the coupler jacket comprise a second guiding track,
wherein the second guiding track has a first transversal section, a second transversal section and a longitudinal or helical section,
wherein the coupler body comprises a second protrusion that engages with the second guiding track.

36. The coupling device according to claim 35,
wherein the coupler body and the coupler jacket are rotatable relative to each other from a fifth rotational position to a sixth rotational position of the coupler jacket relative to the coupler body when the second protrusion abuts against the first transversal section of the second guiding track, and
wherein in the sixth rotational position of the coupler jacket relative to the coupler body a translational movement of the coupler body, the first and second sleeves, and the first and second probes in distal and proximal direction are blocked.

37. The coupling device according to claim 28,
wherein the coupler jacket comprises first tubular component and a second tubular component,
wherein the first tubular component surrounds the second tubular component and surrounds the coupler body, and
wherein the second tubular component surrounds the coupler body.

38. The coupling device according to claim 37,
wherein the first tubular component comprises the first guiding track, and
wherein the second tubular component comprises the second guiding track.

39. The coupling device according to claim 26, further comprising
a locking interface, particularly at a coupler jacket, and
wherein the locking interface is configured for locking the coupling device with a cap of the container.

40. The coupling device according to claim 26,
wherein the first and second probes are moveable along a longitudinal direction relative to a coupler jacket of the coupling device from a proximal end position to a distal end position and vice versa, and
wherein the first and second probes do not extend outside of the coupler jacket when positioned in the proximal end position.

41. The coupling device according to claim 26,
wherein the first extraction aperture is provided at a first height h₁,
wherein the second extraction aperture is provided at a second height h₂, and
wherein the first height h₁ of the first extraction aperture is different from the second height h₂ of the second extraction aperture.

42. The coupling device according to claim 26,
wherein the coupling device is a springless coupling device.

43. A system for draining and venting a container, the system comprising,
a coupling device according to claim 26, and
a container with a dual function closure, the container comprising,
a container body with at least one inlet opening,
a springless cap for closing the inlet opening of the container body,
wherein the cap is attached to the inlet opening of the container body,
wherein the cap comprises a first opening and a second opening,
wherein the cap comprises a first closure insert and a second closure insert,
wherein the first opening is surrounded by a first circumferential wall,
wherein the first circumferential wall comprises a first shoulder,
wherein the second opening is surrounded by a second circumferential wall,
wherein the second circumferential wall comprises a second shoulder,
wherein the first closure insert releasably engages with the first shoulder such that the first opening is fluid tightly closed,
wherein the second closure insert releasably engages with the second shoulder such that the second opening is fluid tightly closed.

44. A system according to claim 43, wherein the coupling device is configured to block the first and the second sleeves at a first predetermined longitudinal position thereby preventing a translational movement of the first and second sleeves in proximal direction,
wherein the first and second probes are in a second predetermined longitudinal position when the first and second sleeves are in the first predetermined longitudinal position, and
wherein the coupling device is configured to allow a further translational movement of the first and second probes from said second predetermined longitudinal position in distal direction only when the first and second sleeves are blocked at the first predetermined longitudinal position;
wherein the first sleeve is configured to fluid tightly engage with the first circumferential wall when the first sleeve is in the first predetermined longitudinal position, and
wherein the second sleeve is configured to fluid tightly engage with the second circumferential wall when the second sleeve is in the first predetermined longitudinal position.

45. A system according to claim 43,
wherein the first and the second closure insert each engage with the corresponding shoulder such that upon axially pushing one of the closure inserts towards a bottom of the container body said closure insert disengages with the corresponding shoulder to be in a disengaged configuration, and
wherein upon axially pulling said closure insert from the disengaged configuration and in a direction away from the bottom of the container body said closure insert re-engages with the corresponding shoulder such that the corresponding opening is again fluid tightly closed.

46. A system according to claim 43,
wherein the coupling device comprises a locking interface configured for locking the coupling device with a cap of the container,
wherein the cap comprises a locking means adapted to engage with the locking interface of the coupling device, and
wherein the locking interface and the locking means are configured to be locked together only in one rotational position of the coupling device relative to the cap.

47. A system according to claim 43,
wherein the first closure insert comprises at least one radially deformable sidewall,
wherein the second closure insert comprises at least one radially deformable sidewall,
wherein the radially deformable sidewall of the first closure insert is adapted to releasably engage with the first shoulder, and
wherein the radially deformable sidewall of the second closure insert is adapted to releasably engage with the second shoulder.

48. Method of mechanically coupling a coupling device to a cap of a container, the method comprising the steps
providing for the container having a container body (S1),
wherein the container body comprises at least one inlet opening and a springless cap attached to the inlet opening closing the inlet opening,
wherein the cap comprises a first opening, a second opening, a first closure insert and a second closure insert,
wherein the first opening is surrounded by a first circumferential wall, and the first circumferential wall comprises a first shoulder,
wherein the second opening is surrounded by a second circumferential wall and the second circumferential wall comprises a second shoulder,
wherein the first closure insert releasably engages with the first shoulder such that the first opening is fluid tightly closed and the second closure insert releasably engages with the second shoulder such that the second opening is fluid tightly closed,
the method further comprising the steps
coupling the container via the springless cap with a coupling device thereby inserting a first probe of the coupling device into the first opening of the cap and inserting a second probe of the coupling device into the second opening of the cap (S2),
disengaging the first closure insert and the first shoulder by axially pushing the first closure insert by the first probe and/or disengaging the second closure insert and the second shoulder by axially pushing the second closure insert by the second probe (S3).

49. Method according to claim 48, further comprising the steps
blocking a first sleeve and a second sleeve of the coupling device at a first predetermined longitudinal position thereby preventing a translational movement of the first and second sleeves in proximal direction (S4),
wherein the first and second probes are in a second predetermined longitudinal position when the first and second sleeves are in the first predetermined longitudinal position, and
allowing a further translational movement of the first and second probes from said second predetermined longitudinal position in distal direction only when the first and second sleeves are blocked at the first predetermined longitudinal position (S5).

50. Method according to claim 49, further comprising the steps
blocking the first and the second probes in distal direction at the second predetermined longitudinal position thereby preventing a translational movement of the first and second probes in distal direction (S6), and
allowing a translational movement of the first and second sleeves from the first predetermined longitudinal position and in proximal direction only when the first and second probes are blocked in distal direction at the second predetermined longitudinal position (S7).
